(19) United States
(12) Patent Application Publication
(10) Pub. No.: US 2003/0228703 A1
(43) Pub. Date: Dec. 11, 2003

(54) Fluorescence resonance energy transfer quantitation and stoichiometry in living cells

(75) Inventors: Adam D. Hoppe, Ann Arbor, MI (US); Joel A. Swanson, Ann Arbor, MI (US)

Correspondence Address: MEDLEN & CARROLL, LLP, Suite 350, 101 Howard Street, San Francisco, CA, 94105, US

(73) Assignee: The Regents of the University of Michigan, Ann Arbor, MI

(21) Appl. No.: 10/408,643

(22) Filed: Apr. 7, 2003

Related U.S. Application Data
(60) Provisional application No. 60/370,166, filed on Apr. 5, 2002.

(51) Int. Cl. G01N 21/64

(52) U.S. Cl. 436/172; 422/82.08

(57) ABSTRACT

The present invention relates to quantitative analysis of molecular interactions in cells. In particular, the present invention provides methods, devices, and systems for determining fluorescence resonance energy transfer between labeled molecules, and for determining stoichiometric measurements of binding interactions based upon fluorescence resonance energy transfer between labeled molecules.

This application claims priority from U.S. Patent Application Serial No. 60/370,166, filed Apr. 5, 2002, herein incorporated by reference in its entirety.

This invention was funded in part with government support under grant number AI-35950 from the National Institute of Allergy and Infectious Diseases at the National Institutes of Health, grant number AI 35950 from the National Institutes of Technology, and from an NIH Cellular Biotechnology Training Program grant. The government may have certain rights in this invention.

### FIELD OF THE INVENTION

The present invention relates to quantitative analysis of molecular interactions in cells. In particular, the present invention provides methods, devices, and systems for determining fluorescence resonance energy transfer between labeled molecules, and for determining stoichiometric measurements of binding interactions based upon fluorescence resonance energy transfer between labeled molecules.

### BACKGROUND OF THE INVENTION

The study of intermolecular interactions inside cells has proven to be very difficult. This is especially due to the miniscule nature of the molecules of interest. A solution has been the use of fluorescence resonance energy transfer (FRET) to measure the timing and location of intermolecular interactions inside cells. Unfortunately, such measurements are largely qualitative because intracellular levels and distributions of donor and acceptor fluorophores are not controllable. In addition, non-FRET fluorescence can confound measurements of FRET and require background correction which can obscure FRET signals. What is needed is a better way to study small molecule structures inside cells.

Moreover, understanding the cellular function of biological molecules requires quantitative studies of their localization and interaction dynamics inside living cells. Interactions between fluorescently labeled molecules can be detected microscopically by fluorescence resonance energy transfer (FRET) (Gordon, G. W. et al. (1998) Biophys. J. 74:2702-2713; Xia, Z., and Y. Liu (2001) Biophys. J. 81:2395-2402), a process in which an excited donor fluorophore transfers energy to a lower-energy acceptor fluorophore via a short-range (<10 nm) dipole-dipole interaction (Lakowicz, J. R. (1999) Principles of Fluorescence Spectroscopy, 2nd ed. Kluwer Academic/Plenum, New York). Binding interactions between donor-labeled and acceptor-labeled proteins can bring fluorophores within the appropriate distance for FRET to occur. Application of FRET to microscopy has become an important tool for live-cell detection of molecular interactions between fluorescently labeled molecules (Sourjik and Berg (2002) Proc Natl Acad Sci USA. 99:123-7; Kraynov et al. (2000) Science 290:333-7; Janetopoulos et al. (2001) Science. 291:2408-11. Yet few FRET studies quantify the stoichiometry of molecular interactions.

The development of spectral variants of green fluorescent protein, such as cyan fluorescent protein (CFP) and yellow fluorescent protein (YFP) have allowed CFP- and YFP-labeled chimeric proteins to be coexpressed in cells as FRET donor and acceptor, respectively, and have allowed microscopic localization of donor-acceptor complexes relative to cellular activities (4 Kraynov, V. S. et al. (2000) Science 290:333-337; Janetopoulos, C. et al. (2001) Science 291:2408-2411). However, despite its initial promise for providing quantitative data on molecular behavior inside cells, FRET microscopy has been largely qualitative, or limited to a single measurement per cell. Thus, although current microscopic methods for detecting FRET determine where bimolecular interactions occur in a cell, they cannot correct for differences in expression levels and local concentrations of fluorescent chimeras inside cells. For example, current methods cannot determine if a low FRET signal is due to an absence of complex or to a local excess of donor or acceptor. Similarly, flow cytometric methods developed for detection of FRET between CFP and YFP provide only limited information about molecular dynamics (6 Chan, F. K.-M. et al. (2001) Cytometry 44).

Thus, what is needed are methods and devices that can image the complete stoichiometry of intermolecular binding events inside living cells. What is also needed are methods and devices that improve quantitation by directly determining concentration ratios and fractions of interacting molecules, even when the fluorescent labels have overlapping excitation and emission spectra. These methods and devices can then be utilized to image, quantitatively, interactions between fluorescently-labeled molecules in living cells.

### SUMMARY OF THE INVENTION

The present invention relates to quantitative analysis of molecular interactions in cells. In particular, in some aspects, the present invention provides methods, devices, and systems for determining fluorescence resonance energy transfer between labeled molecules.

For example, in some embodiments, the present invention provides systems or devices for measuring FRET stoichiometry. In some embodiments, such systems or device comprise: a fluorescence detection component; and a processor configured to calculate FRET stoichiometry from fluorescence information obtained by the fluorescence detection component. The device is not limited to any particular type of detection component. Any detection component that is capable of receiving fluorescent energy and relaying the fluorescent energy to a processor finds use with the present invention. In some preferred embodiments, the detection component comprises a fluorescence microscope.

Any type of fluorescence detection device or system may be employed with the present invention. For example, the present invention may be employed with confocal microscopes and flow cytometers. The present invention also may be used in multiplex and high-throughput detection systems. In some such embodiments a plurality of samples (e.g., in 96-well plates, 384-well plates, etc.) are assay for any desired purpose, including, but not limited to, basic research, screening drugs or other agents for their effect on cells, and the like.

In some preferred embodiments, the detection component is calibrated for α, β, γ, and/or ξ as described herein to permit the determination of a molar ratio of donor and acceptor fluorophores in a cell (e.g., donor and acceptor fluorophores present on one or more target molecules in the cell). In some preferred embodiments, the processor is configured to obtain a value for γ. For example, in some embodiments, the value for γ is obtained by back-calculating from measured values of E_{C}, α, β, I_{A}, I_{D} and/or I_{F} collected from the detection component, wherein the detection component collects data from linked and unlinked biological molecules in a cell. In some preferred embodiments, the processor is configured to obtain a value for 4 from fluorescent information obtained from the detection component.

In some preferred embodiments, the processor obtains a ratio of total acceptor to total donor fluorescence signal to provide a quantitative measure of relative concentrations of biological molecules in a cell. In some such embodiments, the processor is configured to calculate FRET stoichiometry from interacting fluorescent chimerical biological molecules in a cell. In some preferred embodiments, the processor generates data that determines the location and stoichiometry of molecular interactions in a cell.

The present invention also provides methods for using such systems or devices. For example, in some embodiments, the present invention provides a method for measuring FRET stoichiometry, comprising: a) providing a cell containing one or more target molecules and a device comprising i) a fluorescence detection component and ii) a processor configured to calculate FRET stoichiometry from fluorescence information obtained by said fluorescence detection component; b) collecting fluorescent information from the cell using the fluorescence detection component; and c) calculating FRET stoichiometry from the fluorescent information using the processor.

The present invention also provides a device, comprising: a pulsed electromagnetic wave source; a first non-image forming detector configured to receive acceptor wavelength and create a first signal; a second non-image forming detector configured to receive donor wavelength and create a second signal; and a processor configured to receive the first and second signals and to convert the first and second signals into an LFRET ratio. In some embodiments, the pulsed electromagnetic wave source is a laser. In some embodiments, the non-image forming detector comprises a photomultiplier tube, a single-photon counting photomultiplier tube, an ultra-fast photomultiplier tube, a micro channel plate photomultiplier tube, or a CCD camera. In some embodiments, the non-image forming detector detects in a time-correlated single photon counting fashion, a frequency domain fashion, or a time-gated fashion.

The present invention also provides a device, comprising a pulsed electromagnetic wave source; a first non-image forming detector configured to receive a first acceptor wavelength and create a first signal; a second non-image forming detector configured to receive a second acceptor wavelength and create a second signal; and a processor configured to receive and process said first and second signals to calculate a florescence anisotropy value.

The present invention further provides a device comprising a pulsed electromagnetic wave source; a first non-image forming detector configured to receive a first acceptor wavelength and create a first signal; a second non-image forming detector configured to receive a second acceptor wavelength and create a second signal; a third non-image forming detector configured to receive a first donor wavelength and create a first signal; a fourth non-image forming detector configured to receive a second donor wavelength and create a second signal; and a processor configured to receive and process said first and second acceptor wavelength signals and first and second donor wavelength signals to calculate anisotropy decay.

The present invention further provides a method, comprising: providing a sample comprising acceptor and donor fluorophores and any of the devices disclosed herein; and exposing the sample to an electromagnetic wave source; collecting first and second signals; and generating an LFRET ratio from the signals. In some embodiments, the generating step comprises the calculation RLFRET=(AT2×DT1)/(AT1×DT2). The present invention also provides a method, comprising providing a sample comprising acceptor fluorophores and any device of disclosed herein; exposing the sample to an electromagnetic wave source; collecting first and second signals; and calculating a florescence anisotropy value.

The present invention further provides a method comprising: providing a sample comprising acceptor fluorophores and any device disclosed herein; exposing the sample to an electromagnetic wave source; collecting first and second acceptor signals; collecting first and second donor signals; and calculating an anisotropy decay value.

In further aspects, the present invention relates to quantitative analysis of molecular interactions in cells (e.g., in vivo, in culture, etc.). In particular, the present invention provides methods and devices for determining stoichiometric measurements of binding interactions based upon fluorescence resonance energy transfer between labeled molecules.

In other aspects, the present invention relate to devices, methods, and systems for determining stoichiometric measurements of binding interactions based upon fluorescence resonance energy transfer between labeled molecules.

Thus, for example, in some embodiments, the present invention provides a device for measuring FRET stoichiometry, comprising a fluorescence detection component and a processor configured to calculate FRET stoichiometry from fluorescence information obtained by said fluorescence detection component. In some embodiments, the detection component comprises a microscope configured to collect fluorescent energy. In other embodiments, the detection component is calibrated for α, β, γ, and/or ξ to permit the determination of a molar ratio of donor and acceptor fluorophores in a cell.

In yet other embodiments of the device, the processor is configured to obtain a value for γ. In some further embodiments, the value for γ is obtained by back-calculating from measured values of E_{C}, α, β, I_{A}, I_{D} and/or I_{F} collected from the detection component, wherein the detection component collects data from linked and unlinked biological molecules in a cell. In some embodiments, the processor is configured to obtain a value for ξ from information obtained from said detection component. In some embodiments, the processor obtains a ratio of total acceptor to total donor fluorescence signal to provide a quantitative measure of relative concentrations of biological molecules in a cell. In some embodiments, the processor is configured to calculate FRET stoichiometry from interacting fluorescent chimeras in a cell. In some embodiments, the processor generates data that determines the location and stoichiometry of molecular interactions in a cell.

In some embodiments of the device, the device comprises a confocal microscope. In other embodiments, the device comprises a flow cytometer.

In some embodiments of the device, the fluorescence detection component is configured to collect fluorescent information from a plurality of biological samples, and wherein the processor is configured to calculate FRET stoichiometry from said plurality of biological samples. In some further embodiments, the plurality of biological samples comprises 96 or more biological samples.

In other embodiments, the present invention provides a method for measuring FRET stoichiometry, comprising providing a cell containing one or more target molecules, a device comprising a fluorescence detection component, and a processor configured to calculate FRET stoichiometry from fluorescence information obtained by said fluorescence detection component; collecting fluorescent information from the cell using the fluorescence detection component; and calculating FRET stoichiometry from the fluorescent information using the processor.

In some further embodiments of the method, the detection component comprises a microscope configured to collect fluorescent energy. In other further embodiments, the detection component is calibrated for α, β, γ, and/or ξ to permit the determination of a molar ratio of donor and acceptor fluorophores on the one or more target molecules.

In other further embodiments of the method, the processor obtains a value for γ. In yet further embodiments, the value for γ is obtained by back-calculating from measured values of E_{C}, α, β, I_{A}, I_{D} and/or I_{F} collected from the detection component, wherein the detection component collects data from linked and unlinked target molecules in the cell. In some embodiments, the processor obtains a value for ξ from information obtained from the detection component. In some embodiments, the processor obtains a ratio of total acceptor to total donor fluorescence signal to provide a quantitative measure of relative concentrations of said target molecules in said cell. In other embodiments, the processor generates data that determines the location and stoichiometry of said target molecules in said cell.

In some embodiments of the method, the target molecules comprise fluorescent chimerical molecules.

In some embodiments of the method, the device comprises a confocal microscope. In some embodiments, the device comprises a flow cytometer.

In other embodiments, the present invention provides a method for determining, for an interaction between fluorescent donor molecules D and fluorescent acceptor molecules A, a fraction of acceptor molecules in complex with donor molecules (f_{A}), a fraction of donor molecules in complex with acceptor molecules (f_{D}), and a ratio of total acceptor molecules to total donor molecules (R) comprising providing a solution comprising fluorescent donor molecules D and fluorescent acceptor molecules A, and the device as described above; calibrating the device to determine α, β, γ, and ξ; determining E_{C} for the interaction; obtaining fluorescence images or intensities I_{A}, I_{D}, and I_{F}; and utilizing these values in eq. 2 to calculate f_{A}, in eq. 4 to calculate f_{D}, and in eq. 6 to calculate R, where the eqs. 2, 4, and 6 are as described below.

In yet other embodiments, the present invention provides a method for determining, for an interaction between fluorescent donor molecules D and fluorescent acceptor molecules A, a measure proportional to the fraction of acceptor molecules in complex with donor molecules (E_{A}), a measure proportional to the fraction of donor molecules in complex with acceptor molecules (E_{D}), and a ratio of total acceptor molecules to total donor molecules (R), comprising providing a solution comprising fluorescent donor molecules D and fluorescent acceptor molecules A, and the device as described above; calibrating the device to determine α, β, γ, and ξ; obtaining fluorescence images or intensities I_{A}, I_{D}, and I_{F}; and utilizing these values in eq. 3 to calculate E_{A}, in eq. 5 to calculate E_{D}, and in eq. 6 to calculate R, where eqs. 3, 5 and 6 are as described below.

In still other embodiments, the present invention provides a method of determining, for an interaction between fluorescent donor molecules D and fluorescent acceptor molecules A, γ, and ξ, comprising providing a solution comprising linked fluorescent donor-acceptor probe molecules, and the device as described above, determining E_{C} for a linked donor-acceptor probe, such that f_{A} and f_{D} equal one; calculating γ by back-calculating from eq. 3 as

$$γ = \frac{\\ {E}_{C}}{[ \frac{{I}_{F} - β {I}_{D}}{α {I}_{A}} - 1 ]} ,$$

and calculating ξ by back-calculating from eq. 5 as

$$ξ = \frac{γ {I}_{D} {E}_{C}}{( 1 - {E}_{C} ) ( {I}_{F} - α {I}_{A} - β {I}_{D} )} .$$

In yet other embodiments, the present invention provides a method for determining, for an interaction between fluorescent donor molecules D and fluorescent acceptor molecules A, E_{C} by energy transfer rate (E_{C}(ETR)), comprising providing a solution comprising fluorescent donor molecules D and fluorescent acceptor molecules A, and the device as described above; calibrating the device to determine α and β by fluorescence lifetime spectroscopy; determining I_{SE}(t) from component terms I_{F}(t), I_{D}(t), and inferred I_{A}(t); determining I_{FRET}(t) from I_{SE}(t) and deconvolution of I_{F}^{A}(t); obtaining a mean rate constant K_{T} for I_{FRET}(t); and obtaining E_{C} as a direct function of K_{T}.

### DESCRIPTION OF THE FIGURES

FIG. 1A represents one embodiment having a confocal microscope in combination with a pulsed laser illumination source.

FIG. 1B provides an exemplary instrumentation configuration for the detection of donor and acceptor fluorescence decays using TCSPC for LFRET measurements.

FIG. 1C provides an exemplary instrumentation configuration for the detection of acceptor anisotropy.

FIG. 1D provides an exemplary instrumentation configuration for measuring anisotropy decay of both the donor and acceptor.

FIG. 2A presents fluorescence decay from cells in a FRET-negative YFP/CFP configuration.

FIG. 2B presents the data of FIG. 2A replotted as YFP/CFP ratios as a function of time.

FIG. 2C presents fluorescence decay from cells in a FRET-positive YFP/CFP configuration.

FIG. 2D presents the data of FIG. 2C replotted as YFP/CFP ratios as a function of time.

FIG. 2E compares fluorescence lifetime data of FRET-negative (closed circles) and FRET-positive (open circles) YFP/CFP configurations.

FIG. 2F presented as masked version of FIG. 2E to demonstrate exemplary T1 and T2 delay times to calculate a lifetime-enhanced FRET ratio (R_{LFRET}).

FIG. 3 provides an example comparison of anisotropy decay in FRET-positive and FRET-negative YFP/CFP configurations at a pH of 7.2.

FIG. 4A shows data in solution depicting an exemplary relationship between f_{D} and f_{A} when a donor (e.g., CFP) is completely paired and an acceptor (e.g., citrine) is in excess.

FIG. 4B shows data in solution depicting an exemplary relationship between f_{D} and f_{A} when an acceptor (e.g., citrine) is completely paired and a donor (e.g., CFP) is in excess.

FIG. 4C and FIG. 4D presents data collected in solution validating the corrected ratio in measurement of the total acceptor (e.g., citrine) relative to the total donor (e.g., CFP).

FIG. 5 displays various exemplary components of detectable cellular fluorescence in FRET-positive (e.g., CFP-Cit/Cit) experiment useful in calculating R_{LFRET}.

FIG. 6A shows representative data collected from expressed protein constructs when a cell co-expresses CFP-Cit with excess CFP.

FIG. 6B shows representative data collected from expressed protein constructs when a cell co-expresses CFP-Cit with excess citrine.

FIG. 6C shows representative data collected from expressed protein constructs when a cell co-expresses unlinked CFP and Cit to calculate f_{D}.

FIG. 6D shows representative data collected from expressed protein constructs when a cell co-expresses unlinked CFP and Cit to calculate f_{A}.

FIG. 7 shows the concept underlying the development of FRET stoichiometry in some embodiments of the present invention. The component signals of emission spectra for mixtures of CFP (donor) and YFP or citrine (acceptor) with (panel A) and without (panel B) FRET. The region of the CFP excitation spectrum (violet line) transmitted by the donor excitation filter (violet rectangle) excites CFP and, to a lesser extent, YFP.

Consequently, the emission spectra (red line) contain component signals from both fluorophores. For molecules in complex (panel A), donor fluorescence (cyan) decreases, stimulated acceptor emission due to FRET (salmon) increases, and non-FRET acceptor fluorescence (yellow) remains unchanged, relative to molecules not in complex (panel B). Panel C shows that the interactions between donor, acceptor, and donor-acceptor complexes can be measured by four parameters: the efficiency of energy transfer (E) of donor-acceptor complexes, the fraction of acceptor molecules in complex (f_{A}), the fraction of donor molecules in complex (f_{D}) and the ratio of total acceptor to total donor (R). Arrows indicate fluorescence excitation (violet) and component donor fluorescence (cyan), non-FRET acceptor fluorescence (yellow) and stimulated acceptor emission by FRET (salmon).

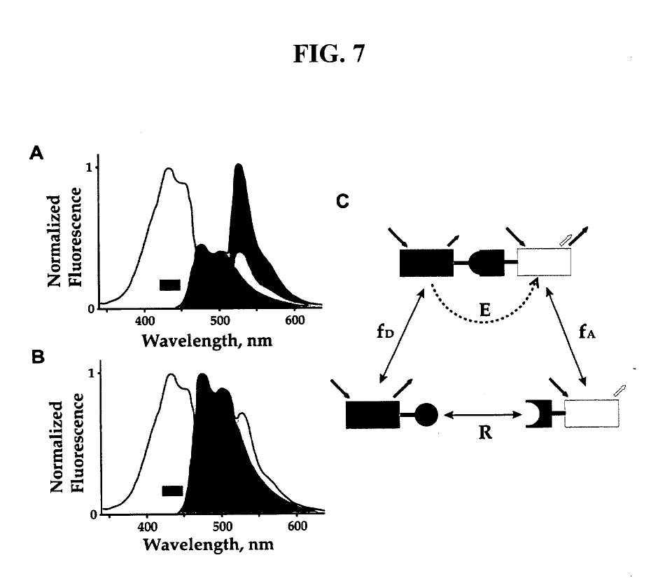

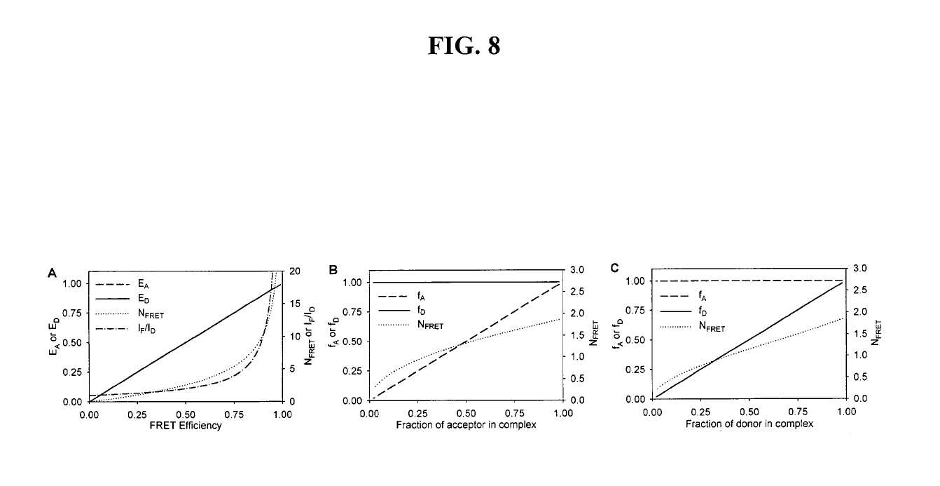

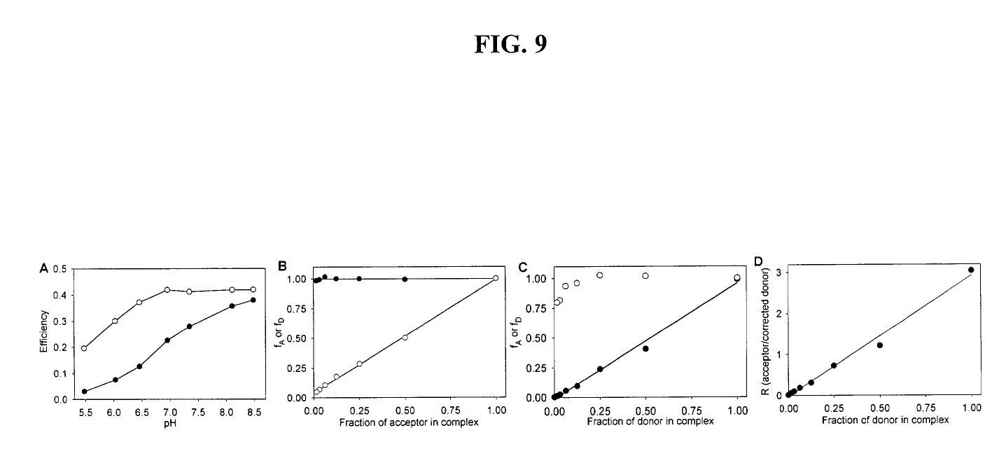

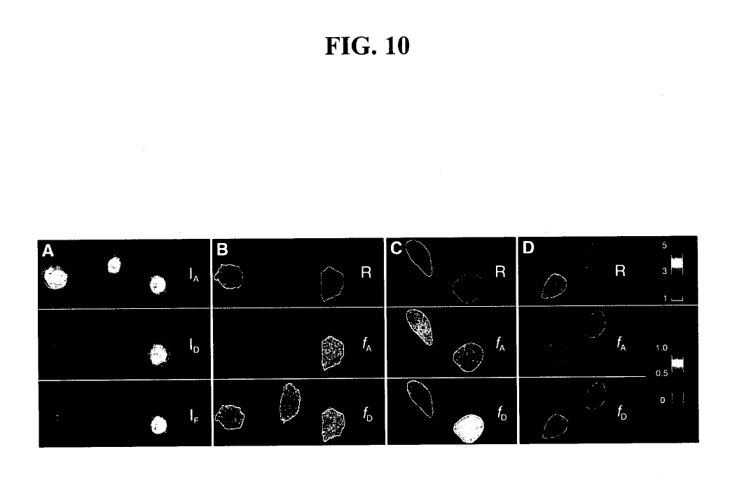

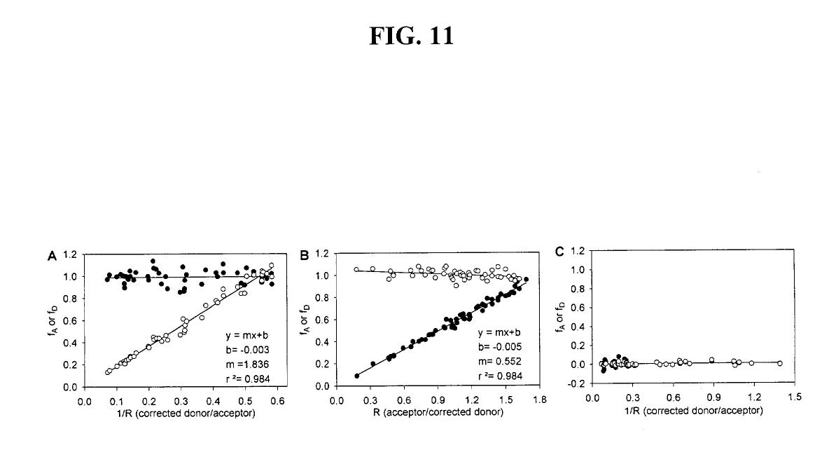

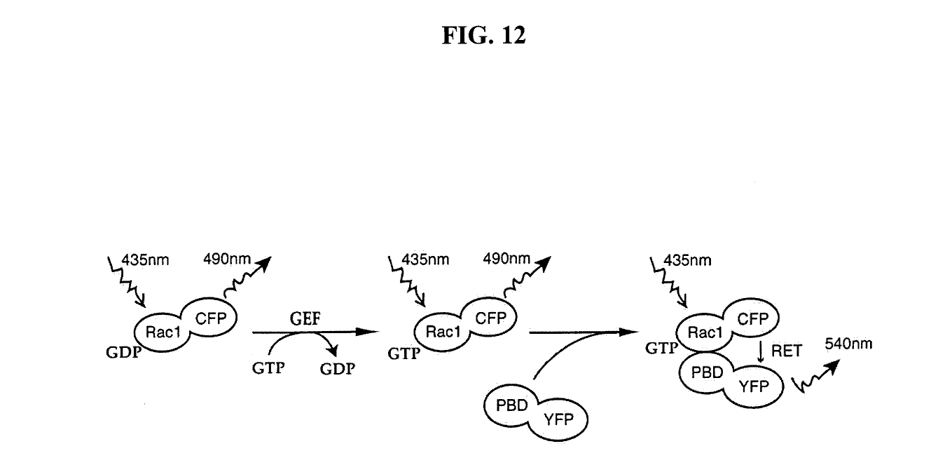

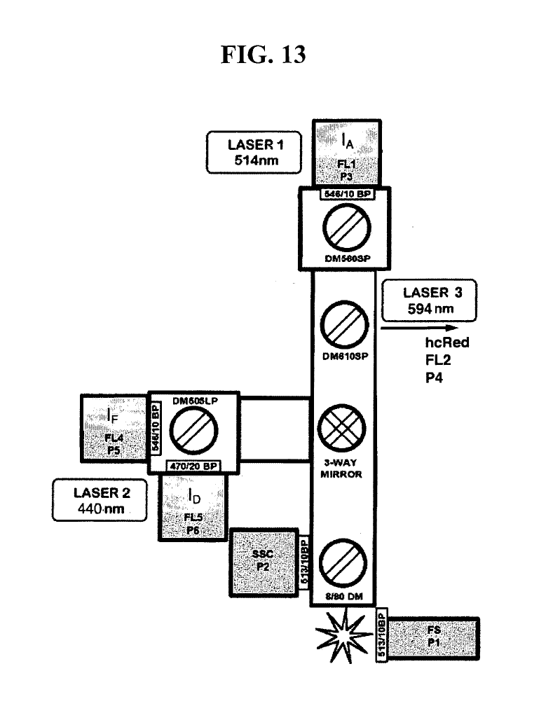

FIG. 8 shows comparisons of FRET stoichiometry with other approaches by mathematical modeling. A mathematical model was generated in which all species and interactions depicted in FIG. 7 were accounted for. As the FRET efficiency of donor-acceptor complexes increases, E_{A} and E_{D} remain linear, whereas other methods approach infinity, as shown in panel A. For mixtures of acceptor plus complex, NFRET is nonlinear, whereas the calculated f_{A} reproduces the fraction of acceptor in complex and f_{D} remains constant at a value of 1, as shown in panel C. When the fraction of donor in complex is varied, NFRET is nonlinear, whereas f_{D} reflects the fraction of donor in complex and f_{A} remains constant.

FIG. 9 shows the verification of FRET stoichiometry by solution measurements of fluorescent proteins and enhanced energy transfer with citrine. FRET efficiency was determined as a function of pH by donor fluorescence lifetime for both CFP alone and linked CFP-YFP or linked CFP-Cit, as shown in panel A. The FRET efficiency was calculated using eq. A, where t_{DA} is the mean fluorescence lifetime of the linked construct and t_{D} is the lifetime of CFP alone. The pH-dependent YFP absorption greatly affected the FRET efficiency near neutral pH (closed circles) whereas citrine (open circles) was unaffected until lower pH (n=3, standard deviation smaller than points) 1 μM CFP-Cit was serially diluted in 1 μM Cit, then f_{A} (open circles) and f_{D} (closed circles) of the solutions were measured by microscopy, as shown in panel B. Since all donor (CFP) in the system was in complex, f_{D} was unaffected by the dilution, whereas f_{A} varied linearly with the fraction of acceptor in complex. 1 μM CFP-Cit was diluted into 1 μM CFP, and the results shown in panel C. f_{D} reflected the fraction of donor in complex whereas f_{A} remained high, indicating that all citrine was in complex. The data shown in panel C was plotted to show the corrected ratio R, as shown in panel D. R reflected the dilutions perfectly for both CFP-Cit plus CFP and CFP-Cit plus Cit (data not shown). α, β, γ and ξ were determined empirically.

FIG. 10 shows FRET stoichiometry imaging of J774 macrophages co-expressing CFP, citrine, or CFP-Cit. Panel A shows the component images IA, ID, and IF for three cells expressing CFP-Cit plus citrine. Fluorescence intensities varied due to differing protein expression levels and to variable cell thickness. Panel B shows processed images from panel A showing R (citrine/CFP), f_{A}, and f_{D}. f_{A} was variable and inversely correlated with the ratio, whereas f_{D} was constant and high, indicating that all donor was in complex. Panel C shows processed images of cells expressing CFP-Cit plus CFP indicating that f_{A} was constant and high, and that f_{D} was variable and correlated with the ratio. Panel D shows processed images of cells expressing CFP plus citrine; R varied but f_{A} and f_{D} remained uniformly low.

FIG. 11 shows the cumulative measurements of R, f_{A}, and f_{D} in J774 macrophages. In cells expressing CFP-Cit plus citrine, f_{D}=1 (closed circles) and f_{A} (open circles) correlated with 1/R (CFP/citrine), as shown in panel A. Cells expressing CFP-Cit plus CFP showed f_{A}=1 and f_{D} correlated with R (citrine/CFP), as shown in panel B. In cells expressing CFP plus citrine (no FRET), f_{A} and f_{D} were uniformly low, despite wide variation in citrine/CFP fluorescence ratios (R).

FIG. 12 shows a bimolecular interaction for FRET stoichiometry. The YFP (citrine)-labeled PBD binds to GTP-bound CFP-Rac1, but not GDP-bound Rac1; thus, FRET reports Rac1 activation. GEF, guanine nucleotide exchange factor

FIG. 13 shows a schematic diagram of a flow cytometer for FRET stoichiometry, showing component detectors (described in Example 11). Laser 3, for detection of hcRed, is added as described in Example 11, Section 2.

### DEFINITIONS

To facilitate an understanding of the present invention, a number of terms and phrases as used herein are defined below:

As used herein, the term “optical detector” or “photodetector” refers to a device that generates an output signal when irradiated with optical energy. Thus, in its broadest sense the term optical detector system is taken to mean a device for converting energy from one form to another for the purpose of measurement of a physical quantity or for information transfer. Optical detectors include but are not limited to photomultipliers and photodiodes.

As used herein, the term “photomultiplier” or “photomultiplier tube” refers to optical detection components that convert incident photons into electrons via the photoelectric effect and secondary electron emission. The term photomultiplier tube is meant to include devices that contain separate dynodes for current multiplication as well as those devices that contain one or more channel electron multipliers.

As used herein, the term “processor” refers to a device that performs a set of steps according to a program (e.g., a digital computer). Processors, for example, include Central Processing Units (“CPUs”), electronic devices, or systems for receiving, transmitting, storing and/or manipulating digital data under programmed control.

As used herein, the term “memory device,” or “computer memory” refers to any data storage device that is readable by a computer, including, but not limited to, random access memory, hard disks, magnetic (floppy) disks, compact discs, DVDs, magnetic tape, and the like.

As used herein, the term “electromagnetic wave” refers to any wavelength of the electromagnetic spectrum, including but not limited to, visible light, ultraviolet, infrared, incandescent, fluorescent, laser light, radio, x-ray, microwave, gamma rays, and any wavelength of the electromagnetic spectrum that is at least in the range of 1×10⁻¹⁵ m to 1×10⁹ m if not greater.

As used herein, the term “non-image forming detector” refers to any detector capable of detecting any wavelength of the electromagnetic spectrum and creating a signal, including detectors capable of forming an image although not used for the purpose of creating an image. Examples include, but are not limited to, CCD cameras, photomultiplier tubes, single-photon counting photomultiplier tubes, ultra-fast photomultiplier tubes, micro channel plate photomultiplier tubes, devices used in conventional fluorometry, devices used in confocal microscopy, devices used in microfluorometry, devices used in arrayed fluorometry, and devices used in multiphoton microscopy.

As used herein, the term “FRET” refers to fluorescence resonance energy transfer, which is the process in which an excited donor fluorophore transfers energy to a lower-energy acceptor fluorophore via a short-range (e.g., less than or equal to 10 nm) dipole-dipole interaction. It also refers to loss of fluorescence from the donor and an increase in fluorescence from the acceptor. For a fixed concentration of molecules, FRET results in an increase in I_{F}, a decrease in I_{D} and no change in I_{A}. Intensities I_{D}, I_{A} and I_{F} depend on the relative concentrations of donors, acceptors and interacting molecules (stoichiometry) and the efficiency at which energy is transferred from the donor to the acceptor (FRET efficiency).

As used herein, the term “FRET stoichiometry” refers to specific donor-acceptor complexes that give rise to a characteristic FRET efficiency (E_{C}), which if measured can allow stoichiometric discrimination of interacting components. Thus, FRET stoichiometry measures FRET efficiencies and the fractions of donor and acceptor labeled molecules in complex for donor-acceptor pairs where non-FRET acceptor fluorescence is detectable in I_{F}.

As used herein, the term “E” refers to FRET efficiency, which is the efficiency at which energy is transferred from the donor to the acceptor in fluorescence resonance energy transfer.

As used herein, the term “E_{C}” refers to a characteristic FRET efficiency for a particular molecular interaction. It also refers to a mean or average E representative of A/D (acceptor/donor) in complex. It also refers to a distance and orientation distribution induced by a particular molecular binding event for which E_{C} describes the mean of the distribution. (Since energy transfer is dependent on both the distance and orientation of the transition dipole moments between the two fluorophores, molecular interactions for a specific pair of donor and acceptor molecules will result in a characteristic FRET efficiency (E_{c}) for that interaction). Use of E_{C} to discriminate fractions of bound molecules is appropriate when the binding interaction gives rise to a reproducible efficiency. For bimolecular interactions, designating a characteristic value for the mean FRET efficiency of donor-acceptor complexes allows stoichiometric measurement of reaction parameters: the ratios of bound and free donor and acceptor chimeras. It also refers to the characteristic efficiency of a linked construct, where f_{A} and f_{D}=1.0, determined from independent measurements.

As used herein, the term “E_{A}” refers to the efficiency calculated from sensitized emission (A denotes dependence on the fraction of acceptor in complex). It is the product of the true efficiency and the fraction of acceptor in complex. It incorporates both FRET efficiency and fraction of A (acceptor) in complex.

As used herein, the term “E_{D}” refers to the efficiency calculated relative to donor fluorescence (D denotes dependence on the fraction of donor in complex). It is the apparent donor efficiency; =E f_{D}. It incorporates both FRET efficiency and fraction of D (donor) in complex.

As used herein, the term “I_{A}” refers to the intensity or image at the acceptor excitation and acceptor emission. It also refers to the acceptor excitation and acceptor emission,

$$F ( {λ}_{A}^{ex} {λ}_{A}^{em} ) .$$

The acceptor fluorescence in I_{A} is unaffected by FRET and is proportional (P₂) to the concentration of total acceptors [A_{T}] present.

As used herein, the term “I_{D}” refers to the intensity or image at the donor excitation and donor emission. It also refers to the donor excitation and donor emission,

$$F ( {λ}_{D}^{ex} {λ}_{D}^{em} ) .$$

The fluorescence intensity in I_{D} is equal to the concentration of total donors [D_{T}] times a proportionality constant P₁ less the fraction energy (E) not emitted from the fraction of donor molecules (f_{D}) in complex.

As used herein, the term “I_{F}” refers to the intensity or image at the donor excitation and acceptor emission. It also refers to the donor excitation and acceptor emission,

$$F ( {λ}_{D}^{ex} {λ}_{A}^{em} ) .$$

I_{F} is made up of a portion of the donor spectrum, related to I_{D} by β, plus the portion of emissions from the acceptor whose fluorescence is related to I_{A} by α. I_{F} often contains signal due to spectral overlap of the donor and acceptor emissions, even for mixtures of uncomplexed donor and acceptor that do not exhibit FRET.

As used herein, the term “f_{A}” refers to the fraction of acceptor in complex as measured by FRET stoichiometry.

As used herein, the term “f_{D}” refers to the fraction of donor in complex as measured by FRET stoichiometry.

As used herein, the term “R” refers to the molar ratio of acceptor to donor measured by FRET stoichiometry. It also refers to the absolute concentration ratio of acceptor [A_{T}] to donor [D_{T}].

As used herein, the term “α” refers to the proportionality constant relating acceptor fluorescence at the acceptor excitation to the donor excitation. It corrects for non-FRET fluorescence of A (acceptor) in the I_{F} intensity or image.

As used herein, the term “β” refers to the proportionality constant relating donor fluorescence detected at the acceptor emission relative to that detected at the donor emission. It corrects for non-FRET fluorescence of D (donor) in the I_{F} intensity or image.

As used herein, the term “γ” refers to the ratio of the extinction coefficient of the acceptor to the donor at the donor excitation. In methods of invention, γ is obtained by back-calculation from measured values of E_{C}, α, β, I_{A}, I_{D} and I_{F} collected directly in, for example, a microscope using linked and unlinked CFP and citrine.

As used herein, the term “ξ” refers to a proportionality constant relating the sensitized acceptor emission to the decrease in donor fluorescence due to FRET. The term ξ accounts for the fraction of sensitized acceptor emission detected in I_{F} relative to the fraction of donor fluorescence not transferred by FRET. It also estimates the donor fluorescence lost due to FRET. It also allows measurement of donor participation in FRET complexes. It eliminates need for acceptor photobleaching to determine fraction of energy lost from donor.

As used herein, the terms “DFL” and “E_{C}(DFL)” refer to donor fluorescence lifetime. It refers to an E_{C} of probes as measured by donor fluorescence lifetime.

As used herein, the terms “ETR” and “E_{C}(ETR)” refer to energy transfer rate. E_{C} is tested by measuring energy transfer rate (E_{C}(ETR))

As used herein, the term “k_{T}” refers to an intrinsic descriptor of the energy transfer process, which is independent of the fraction of molecules participating in energy transfer.

As used herein, the term “τ” refers to fluorescence lifetimes.

As used herein, the term “τ_{D}” refers to a fluorescence lifetime of a donor D.

As used herein, the term “τ_{DA}” refers to a fluorescence lifetime donor D in a complex with acceptor D.

As used herein, the term “I_{F}(t)” refers to a mixture of three intensity decays: αI_{A}(t), βI_{D}(t), and I_{SE}(t).

As used herein, the term “αI_{A}(t)” refers to a direct (non-FRET) excitation of the acceptor (time-resolved αI_{A}, or αI_{A}(t)).

As used herein, the term “βI_{D}(t)” refers to an emission of the donor (time-resolved βI_{D}, or βI_{D}(t)).

As used herein, the term “I_{SE}(t)” refers to a sensitized emission of the acceptor due to FRET (time-resolved I_{SE}, or I_{SE}(t)).

As used herein, the term “I_{F}^{A}(t)” refers to an acceptor decay measured using pure acceptor (or cells expressing acceptor only) at

$${λ}_{D}^{ex} {λ}_{A}^{em} ( {I}_{F} ) .$$

As used herein, the term “Î_{F}^{A}(t)” refers to a shape of the acceptor decay obtained by normalizing I_{F}^{A}(t) to 1.

As used herein, the term “CFP” refers to cyan fluorescent protein, and is a donor (D).

As used herein, the term “YFP” refers to yellow fluorescent protein, and is an acceptor (A).

As used herein, the term “citrine” refers to an improved YFP, and is an acceptor (A).

The term “test compound” refers to any chemical entity, pharmaceutical, drug, and the like that can be or might be used to treat or prevent a disease, illness, sickness, or disorder of bodily function, or otherwise alter the physiological or cellular status of a sample. Test compounds comprise both known and potential therapeutic compounds. A test compound can be determined to be therapeutic by screening using the screening methods of the present invention.

As used herein, the term “sample” is used in its broadest sense. In one sense it can refer to a tissue sample (e.g., a cell). In another sense, it is meant to include a specimen or culture obtained from any source, as well as biological. Biological samples may be obtained from animals (including humans) and encompass fluids, solids, tissues, and gases. Biological samples include, but are not limited to blood products, such as plasma, serum and the like. These examples are not to be construed as limiting the sample types applicable to the present invention.

### DESCRIPTION OF THE INVENTION

Certain preferred and exemplary embodiments of the present invention are described below. The present invention is not limited to these particular embodiments.

Fluorescence Resonance Energy Transfer Detection and Quantitation

In some embodiments, the present invention is related to systems and methods to detect and quantitate induced secondary fluorescence via fluorescence resonance energy transfer (FRET). Specifically, FRET is the process by which the fluorescent emissions from a donor probe induce the fluorescence of an acceptor probe in close proximity (e.g., 10 nm). For example, FRET spectroscopy and microscopy have been used to study the interactions between chimeric proteins containing yellow fluorescent protein and cyan fluorescent protein. Current methods of detecting FRET are limited by the spectral overlap of donor and acceptor fluorescence emission. This is an obstacle for development of microscopic and related methods for the intracellular detection of FRET by confocal microscopy and related techniques. In some preferred embodiments of the present invention, this problem is alleviated such that biological reactions or measurment of intra-molecular distances on proteins or oligonucleotides or other biological molecules may be detected.

Fluorescence Resonance Energy Emission

Even though it is not necessary to understand the mechanism to practice the present invention, and the present invention is not limited to any particular mechanism, it is believed that a fluorophore emits light by essentially three steps. First, the fluorophore absorbs a photon and is essentially instantaneously converted from a low energy, ground state, to an excited state. Second, the fluorophore remains in the excited state for a brief period of time. Third, the fluorophore returns to its low energy, ground state, and emits a photon (i.e., light) as fluorescence. For example, if a fluorophore is excited by a brief, 1 picosecond pulse of light, and fluorescence is measured at different times after the light pulse, one observes maximal fluorescence immediately after the light pulse, less fluorescence 1 nanosecond after the light pulse, and even less fluorescence 2 nanoseconds after the light pulse. The mathematical profile created by these temporal fluorescence measurements is exponential in nature and represents fluorescence decay. The presence of FRET alters the fluorescence decay of both donor probes and acceptor probes. The donor probes may either be identical (i.e., homo-FRET detection) or different (i.e., hetero-FRET detection) wherein the probes are selected in order to optimize the detection of both the spectral and lifetime aspects of FRET. Specifically, donor fluorophore probe lifetimes shorten. The acceptor fluorophore probe lifetimes, however, lengthen because their maximal fluorescence is delayed in relation to the initiation of the excitation pulse. After the acceptor fluorophore probes reach their maximal intensity, their rate of decay is characteristic of the specific molecule used as the acceptor fluorophore probe.

Generally, the various embodiments of this invention disclose systems and methods for the enhanced detection of FRET using an illumination source (e.g. confocal illumination source or any other electromagnetic wave source). The illumination source may be, but is not limited to, a multi-photon arrangement. The illumination source is directed at samples containing donor and acceptor fluorescent probes in order to raise the probes to their excitation state using a confocal, point or small area illumination. The illumination light source may be, but not limited to, incandescent, fluorescent, ultraviolet, infrared, or laser light. A preferred illumination light source is a pulsed laser light selected for a wavelength compatible with the excitation wavelength, or other wavelengths acceptable for multi-photon excitation, of the donor fluorophore probe. Following the initial donor probe excitation and FRET-induction of the acceptor probe, the fluorescence decay (i.e., time-domain) or signal decay modulation (i.e., frequency-domain) of both the donor probe and acceptor probe may be measured using a time-gated, time-correlated single photon counting detection system (TCSPC) or any other analogous detection methods selected for the simultaneous detection of emission wavelengths from the donor fluorophore probe and acceptor fluorophore probe. Certain embodiments of the present invention contemplate the additional and/or simultaneous detection of the fluorescence anisotropic decay of both the donor probe and the acceptor probe in further enhance the FRET detection sensitivity. Such embodiments of the present invention are not limited to time-domain detection, but also include use of frequency-domain, other modulation-type detection with minor electronic modifications based on well-known mathematical relationships, or other detection modes.

Anisotropic decay of fluorescent probes is dependent upon polarization. Specifically, fluorescence emission from an immobile fluorophore maintains a high degree of polarization. For example, FRET analysis routinely use yellow and cyan fluorescent proteins because they are rigidly positioned fluorophores and their non-FRET fluorescence response has long rotational correlation times (i.e., highly polarized with a concomitant high average anisotropy). The stable nature of these fluorescent proteins is useful in the measurement of FRET because the presence of FRET may reduce polarization by as much as 96%. These alterations in anisotropic decay in the presence of FRET is extremely useful for studies using living cells. An alternative embodiment contemplates combination with a two-photon excitation system because this process results in a 1.425-fold increase in anisotropy.

Data analysis following the collection of FRET can be carried out in various ways. This invention contemplates the division of the emission spectra from the acceptor fluorophore probe and the acceptor fluorophore probe and normalization to the initial amplitudes as a simplistic calculation of LFRET. As is explained below, in combination with the Examples, preferred embodiments of this invention disclose comprehensive models in which the intrinsic behaviors or decay rates provide an enhancement of the sensitivity and the quantitative measurement of FRET efficiency.

The FRET Inducing/Detection Apparatus

In some embodiments, devices that are designed for the induction and detection of FRET should have a light source to illuminate the sample in combination with an emission detector. The apparatus may also be able to screen the emission detector from the light source in order to reduce or eliminate background illumination. In one embodiment of the present invention, this latter problem is alleviated by choosing a confocal illumination source instead of a wide-field illumination source.

The detection of at least two different emission wavelengths is disclosed following exposure of an entire sample with a wide-field illumination source in U.S. Pat. No. 5,911,952 to Tsuji. The resulting fluorescent emissions from both the donor and FRET-induced acceptor probes are magnified through a microscope, separated by a dichroic mirror and formed into individual images. Thereafter, CCD cameras or photomultipliers provide digitized signals into the computer processor for a comparative image analysis of the respective emissions.

Wide-field illumination of a sample is also used to measure the phase and modulation response of a fluorescing molecule in U.S. Pat. No. 5,818,582 to Fernandez et al. This reference does not disclose a device incorporating confocal epifluorescence microscopy utilizing non-imaging detectors.

A preferred embodiment of the present invention has a confocal epifluorescence illumination device that is in systems that analyze both time-dependent and frequency-dependent responses of a fluorescing molecule. Generally, these systems form an image that utilizes extensive processing and comparative software to determine changes in fluorescence intensity. A system described in U.S. Pat. No. 6,326,605 to Modlin et al. is limited to a single photoluminescent detector that detects light from all photoluminescence modes. Additionally, the Modlin et al. device is only equipped with a pre-detector filter wheel that alters emission light intensity lacks a capability to select for specific wavelengths.

Another embodiment of the present invention having a confocal epifluorescence illumination device integrates a tracking system. This tracking system allows selective movement of the transmission beam to specific microwells or exact positions within a sample as described in U.S. Pat. No. 6,310,687 to Stumbo et al. and is herein incorporated by reference. This embodiment of the present invention results in an ability to selectively locate probes on a sample for diagnostic purposes.

A preferred embodiment of the present invention contemplates confocal illumination using a laser as a light source because laser light is collimated. The confocal nature of the illumination system, when combined with the collimation of a laser beam, results in very precise and accurate positional illumination on the sample. FRET production induced by laser scanning confocal illumination is disclosed in U.S. Pat. No. 6,342,379 B1 to Tsien et al. and is herein incorporated by reference in its entirety. Tsien et al. separates the donor and acceptor emissions by dichroic mirrors for simultaneous and independent detection. The emissions, however, are routed to an image-forming detector. A preferred embodiment of the present invention using a non-image forming detector measures the emitted fluorescence decay of both the donor probe and acceptor probe at least two time points after fluorescence induction.

Another preferred embodiment of the present invention combines the precision illumination of confocal illumination with the improved resolution and ability to detect minimal probe emission intensity by using a confocal detection system. An apparatus detecting the FRET-induced acceptor emission combining a confocal illumination device with a confocal detection device is disclosed in United States patent application No. 2001/0014850 A1 to Gilmanshin et al. and is herein incorporated by reference in its entirety. The reference describes a single dichroic mirror located in the light path providing simultaneous reflection of the excitation light to the sample, and transmission of the sample emission to the detector.

Various embodiments of the present invention contemplate arrangements for detection or imaging of FRET that include, but are not limited to, widefield illumination microscopy, confocal microscopy, conventional fluorometry, microfluorometry, and arrayed fluorometric detection for plate readers and high throughput screening techniques. A preferred embodiment of the present invention contemplates any technology using an image or non-imaging detector with the exception of widefield illumination sources.

Fluorescence microscopes for detecting FRET generally contain three combinations of filters: donor excitation plus donor emission (λ^{ex}_{D}λ^{em}_{D}), acceptor excitation plus acceptor emission (λ^{ex}_{A}λ^{em}_{A}), and donor excitation plus acceptor emission (λ^{ex}_{D}λ^{em}_{A}); producing the corresponding fluorescence images I_{D}, I_{A} and I_{F}. I_{D} and I_{F} should discriminate donor and acceptor fluorescence, with negligible transmission of one fluorophore into the other's filter set. However, I_{F} often contains signal due to spectral overlap of the donor and acceptor emissions, even for mixtures of uncomplexed donor and acceptor pairs that do not exhibit FRET. When FRET is detected (i.e., when donor and acceptor pairs are linked) as sensitized acceptor emission, I_{F} increases, I_{D} decreases, and I_{A} remains unchanged. For biosensors, whose donor and acceptor pair stoichiometry is fixed, changes in FRET due to intramolecular rearrangements can be detected by the ratio I_{F}/I_{D}, which increases non-linearly with FRET efficiency. On the other hand for unlinked donor and acceptor pairs, whose stoichiometry varies widely between and within the cells, FRET for donor-acceptor pairs is accompanied by an increase in I_{F}, after subtraction of non-FRET I_{F} background signal. Imaging detection systems are limited in this type of measurement because they do not quantify FRET efficiency (i.e., the fraction of energy transferred from the donor probe to the acceptor probe). Consequently, an imaging detection system cannot determine if a low FRET signal is due to low FRET efficiency or to a local excess of donor and acceptor pairs.

In a preferred embodiment of the present invention the components I_{D}, I_{A} and I_{F} are used to obtain FRET efficiencies and can determine the fraction of donor and acceptor pairs.

Specifically, the efficiency of energy transfer (i.e., E_{C}) is calculated from sensitized acceptor emission using the following formula (Equation V).

$${E}_{C} = γ [ \frac{{I}_{F} - β {I}_{D}}{α {I}_{A}} - 1 ] ( \frac{1}{{f}_{A}} )$$

where EC is the characteristic FRET efficiency of the donor-acceptor pair, f_{A} is the fraction of acceptor-donor pairs, α and β are independently measured proportionality constants for acceptor and donor fluorescence, respectively, through the FRET filter set (i.e., α=I_{F}/I_{A} when only acceptor is present, and β=I_{F}/I_{D} when only donor is present), and γ is the ratio of the extinction coefficients of the acceptor to the donor, both measured at the donor's excitation maximum. Since energy transfer is dependent on both the distance and orientation of the transition dipole moments between the two fluorophores, each type of molecular interaction resulting in a donor-acceptor pair will have a different E_{C}.

A determination of the paired donor fraction (f_{D}) utilizes an estimation of donor fluorescence in the absence of FRET. One embodiment of the present invention enables estimation of the paired donor fraction by using the decrease in donor fluorescence during FRET in combination with independently calibrating the extent to which stimulated acceptor emission increases as donor fluorescence decreases. As such, f_{D} can be calculated from the following formula (Equation VI):

$${f}_{D} = ⌊ 1 - \frac{{I}_{D}}{( {I}_{F} - α {I}_{A} - β {I}_{D} ) \frac{ξ}{γ} + {I}_{D}} ⌋ ( \frac{1}{{E}_{C}} )$$

Where ξ accounts for the difference between the shape of the acceptor and donor emission spectra and the quantum efficiency of the acceptor. When E_{C} is unknown, the apparent donor efficiency can be determined as

$${E}_{D} = {E}_{C} {f}_{D} = [ 1 - \frac{{I}_{D}}{( {I}_{F} - α {I}_{A} - β {I}_{D} ) \frac{ξ}{γ} + {I}_{D}} ]$$

The determination of the total donor fluorescence also allows calculation of the true ratio of total acceptor and donor as show in the formula below (Equation VII):

$$R = \frac{[ A ]}{[ D ]} = ( \frac{ξ}{{γ}^{2}} ) \frac{{I}_{A}}{( {I}_{F} - α {I}_{A} - β {I}_{D} ) \frac{ξ}{γ} + {I}_{D}}$$

These algorithms correct for variable fluorescence path lengths, and should therefore provide, at each pixel, the relative concentrations of donor, acceptor and donor-acceptor pairs. Also determinable is if either, donor or acceptor, is in local excess of the donor-acceptor pairs.

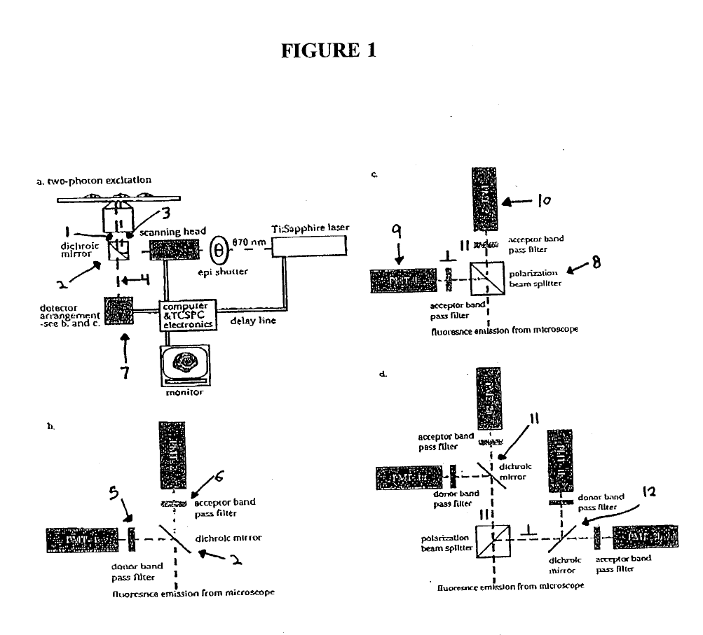

A typical arrangement for microscopic point illumination and emission detection is illustrated in FIG. 1A (confocal fluorescence microscopy). A preferred embodiment of the present invention is shown in FIG 1B where the emission spectra of both the acceptor fluorophore probe and donor fluorophore probe are collected simultaneously. The light 1 impinging on the dichroic mirror 2 is selected to reflect the donor fluorescence 3 and to transmit the acceptor fluorescence 4. The donor fluorescence 3 and the acceptor fluorescence 4 pass through respective bandpass filters 5 and 6 prior to encountering an ultra-fast detection system that may comprise, but is not limited to, confocal microscope magnification, cooled charged-coupled device (CCD) cameras, photomultiplier tubes, ultra-fast photomultiplier tubes, MCP-photomultiplier tubes, time-correlated photon-counting computer card and gated detectors. A preferred embodiment of the present invention contemplates non-imaging detectors that convert the emission spectra directly into digitized signal for computer processing and ratiometric analysis. The detection system 7 is interfaced with electronics that count the number of photons detected at times after the laser pulse excited the sample in the TCSPC mode. In an alternative embodiment, a frequency generator or other compatible electronic device allows detection and measurement of the photons in the frequency-domain.

A preferred embodiment of the detection system involves the measurement of FRET by a multichannel anisotropy detection. The detection scheme depicted in FIG. 1C illustrates a simplified example of such a system. Of particular note the dichroic mirror 2 in FIG. 1B is replaced by a polarization beam splitter 8 wherein both bandpass filters 5 & 6 are selected to pass the acceptor emission wavelength and measure the intensity of the parallel polarization wavelengths (i.e., I) or the intensity of perpendicular polarization wavelengths (i.e., I_{⊥}). The fluorescence anisotropy (r) is calculated using the following formula (Equation I):

$$\begin{matrix}r = I + {GI}_{⊥} \\ I + 2 {GI}_{⊥}\end{matrix}$$

where I_{⊥} is the intensity of the δ-polarization detected on PMT 9 and I is the intensity of the ρ-polarization detected on PMT 10. G is a correction factor to calibrate the detection efficiency of the two polarizations. G is calibrated by using samples having known anisotropy.

A preferred embodiment of the present invention contemplates an alternative detector scheme shown in FIG. 1D. As in FIG. 1C, the fluorescence emissions 3 and 4 are separated by a polarization beam splitter 8. However, subsequently the parallel and perpendicular polarizations independently encounter a dichroic mirror 11 and 12, respectively that separates the polarizations into the acceptor wavelength and donor wavelength for detection using PMT 9 and PMT 10. An alternative embodiment of the present invention contemplates detectors that are ultra-fast PMT's or MCP-PMT's that are interfaced with the TCSPC detection system. This configuration allows a determination of a decay curve for the parallel and perpendicular polarization for each wavelength. In a calculation analogous to Equation I, the fluorescence decay of each polarization is used to determine the anisotropy decay r(τ) determined by the following formula (Equation II):

$$\begin{matrix}r ( τ ) = I ( τ ) - {GI}_{⊥} ( τ ) \\ I ( τ ) + 2 {GI}_{⊥} ( τ )\end{matrix}$$

where I_{⊥}(τ) and I (τ) are the intensity decays at each polarization and G is the same correction factor as shown in Example I. In the absence of FRET, donor and acceptor fluorophore probes having similar lifetimes (e.g., yellow and cyan fluorescent proteins) yield long anisotropic decays by this detection mode. One the other hand, when FRET is present, the acceptor anisotropic decay shortens and the donor anisotropic decay remains constant. Alternatively, the donor anisotropic decay may increase due to a shortened lifetime and increased molecular size. In an alternative preferred embodiment, this detection scheme may be a gated detection scheme combined with an increased illumination source. It is contemplated that this embodiment is compatible with the same detector schemes illustrated in FIG. 1C and FIG. 1D above.

Methods of Calculating LFRET Ratios

The detection of FRET-induced acceptor fluorescence has resulted in ratiometric calculations. Ratiometric FRET calculations have not been previously combined with confocal epifluorescent illumination that provides a better resolution of the emitted signals. The previous methods for detecting FRET-induced acceptor fluorescence using confocal epifluorescent illumination technology do not separate the donor and acceptor emissions using a dichroic mirror arrangement so that each emission may be processed independently. Furthermore, current ratiometric FRET calculations using emissions generated from confocal epifluorescent illumination technology do not calculate donor/acceptor fluorescence decay at more than one time-point. The present invention provides a FRET detecting technology that results in the calculation of a life-time decay curve ratio or LFRET. The determination of the LFRET ratio takes advantage of an ability to simultaneously measure the donor and acceptor fluorescence decay at two different time-points. This measurement is achieved by combining confocal epifluorescence microscopic illumination with separation of the resulting donor and acceptor probe fluorescent emissions by dichroic mirrors into individual non-imaging detectors.

The importance of LFRET measurements provides quantitative data on molecular behavior inside cells. Current intracellular methods of FRET microscopy is limited to qualitative or single measurements. The measurement of intracellular FRET is calculated in arbitrary units that represents the increase in acceptor probe fluorescence due to FRET-induction.

A novel feature of the present invention is the use of non-imaging detectors, however, where the signal processing results in the calculation of LFRET ratios is described herein for the first time.

FRET is used to measure changes in membrane potentials in U.S. Pat. No. 6,342,379 B1 to Tsien et al. by measuring emission ratio changes between fluorescent acceptor and a fluorescent donor measured by emission ratio changes. Similarly, an independent measurement of a donor probe and FRET-induced acceptor probe fluorescence are described in U.S. Pat. No. 5,776,782 to Tsuji. These emission ratios are measured at one time interval and provide no information concerning life-time decay of either emission spectra.

A modified use of ratiometric FRET-induced fluorescence detects the translational motion of “extended objects” (e.g., polynucleotides or other polymers) as described in United States patent application No. 2001/0014850 A1 to Gilmanshin et al. The extended object comprises a pair of probes (either donor or acceptor) while a second, and single, donor or acceptor probe is maintained in a fixed position. Correlated-FRET emissions are measured, termed autocorrelation, measured as a ratio between the relative timing of the induction of the first and second probe conjugated to the extended object.

The measurement of FRET ratios between two identical fluorescent probes residing on the same protein is disclosed in Gautier et al., Biophysical Journal (2001). The technique uses epi-fluorescence imaging techniques using wide-field illumination and confocal microscopy imaging to create the detected emission signal. Polarization filters separate the emission into two parallel and two perpendicular components. Anisotropy was measured using sequential measurements from the same sample spot.

Fluorescence Resonance Energy Transfer-Based Stoichiometry in Living Cells

In some embodiments, the present invention relates to quantitative analysis of molecular interactions in cells by measuring FRET-based stoichiometry. In particular, the present invention provides methods and devices for determining stoichiometric measurements of binding interactions based upon fluorescence resonance energy transfer (FRET) between labeled molecules. These methods are referred to as “FRET stoichiometry.” Thus, the present invention provides methods and devices that can measure FRET efficiency and the relative concentrations of donor, acceptor and donor-acceptor complexes inside cells.

An advantage of the present invention is that it provides a way to measure parameters of chemical reactions inside intact cells, whereas previously, such measurements were only possible in solutions outside of intact cells. Previously, FRET was typically used to measure the distance between interacting (i.e., donor and acceptor) fluorophores in solutions. However, the methods provided by the present invention allow the determination of the stoichiometry of a reaction, or the determination of the concentrations of the products and reactants, and in particular for binding reactions.

Thus, the present invention provides methods for analysis of FRET inside cells, which utilize the same component signals as have been used by other methods but in a new way, allowing quantitation of the equilibrium distribution of donor and acceptor compounds. For example, FRET stoichiometry allows rapid and repeatable quantitative measurement of the binding interactions between proteins labeled with fluorescent donors and acceptors, such as CFP, YFP, or citrine, while eliminating the need for photobleaching to quantify donor quenching by FRET, as was required for previous methods. The ability to measure the stoichiometry of interacting fluorescent chimeras opens new areas of intracellular chemistry to quantitative study. These technologies are also adaptable to widefield microscopy, confocal microscopy, flow cytometry, and other techniques. FRET stoichiometry is especially useful for studies of the behaviors of molecules in their native pathways and of the binding dynamics of membrane localized proteins and microdomains. For example, application of these methods and devices to fluorescent chimeras that are intrinsic components of signaling pathways allows quantitative analysis of the spatially organized chemistries that constitute signal transduction.

I. Development of the Present Invention

A. Background

1. Existing Methods to Measure FRET Efficiency.

FRET efficiency, E, is the fraction of energy transferred from the excited donor to the acceptor. It is an important descriptor of bimolecular interactions producing FRET. In the fluorometer, E is reliably measured by three different approaches.

The most direct approach is by the fluorescence lifetime of the donor molecule, where efficiency is given by:

$$E = ⌊ 1 - \frac{{τ}_{DA}}{{τ}_{D}} ⌋ \qquad ( eq . A )$$

where τ_{D} is the mean fluorescence lifetime of the donor (fluorescence lifetime is the average time for a population of excited fluorophores to decrease to 1/e (Lakowicz, J. R. (1999) Principles of Fluorescence Spectroscopy, 2nd ed. Kluwer Academic/Plenum, New York), and τ_{DA} is the mean fluorescence lifetime of the donor in the presence of acceptor where all donor is in complex with acceptor. This approach is powerful, in that the lifetime is an intrinsic property of fluorescence and does not depend on the concentration of donor molecules.

A second approach, equally valid but dependent on concentration, uses the decrease in fluorescence emitted from the donor given by

$$E = ⌊ 1 - \frac{{F}_{DA} ( {λ}_{D}^{ex} {λ}_{D}^{em} )}{{F}_{D} ( {λ}_{D}^{ex} {λ}_{D}^{em} )} ⌋ ( \frac{1}{{f}_{D}} ) \qquad ( eq . B )$$

where

$${F}_{D} ( {λ}_{D}^{ex} {λ}_{D}^{em} )$$

is the donor fluorescence at a given concentration, and

$${F}_{DA} ( {λ}_{D}^{ex} {λ}_{D}^{em} )$$

is the donor fluorescence, at the same concentration, in the presence of acceptor

$$( {λ}_{D}^{ex} {λ}_{D}^{em} )$$

indicates the wavelengths of light as the donor's excitation

$$( {λ}_{D}^{ex} )$$

and emission

$$( {λ}_{D}^{em} )$$

optima). For microscopy, this method has been approximated by measuring the fluorescence of the donor in the presence of acceptor,

$${F}_{DA} ( {λ}_{D}^{ex} {λ}_{D}^{em} ) ,$$

then photobleaching the acceptor and measuring the increased donor fluorescence,

$${F}_{D} ( {λ}_{D}^{ex} {λ}_{D}^{em} )$$

(Kenworthy, A. K. et al. (2000) Mol. Biol. Cell 11:1645-1655; Zacharias, D. A. et al. (2002) Science 296:913-916).

The third option, called sensitized emission, refers to the enhanced fluorescence observed from the acceptor due to energy transfer from the donor. This is obtained from the ratio of fluorescence from the acceptor in the presence

$$( {F}_{AD} ( {λ}_{D}^{ex} {λ}_{A}^{em} ) )$$

and absence

$$( {F}_{A} ( {λ}_{D}^{ex} {λ}_{A}^{em} ) )$$

of the donor (Lakowicz, J. R. 1999. Principles of Fluorescence Spectroscopy, 2nd ed. Kluwer Academic/Plenum, New York), exciting at the donor's excitation optimum

$$( {λ}_{D}^{ex} )$$

and detecting at the acceptor's emission optimum

$$( {λ}_{A}^{em} ) :$$

$$E = \frac{{ϵ}_{A} ( {λ}_{D}^{ex} )}{{ϵ}_{D} ( {λ}_{D}^{ex} )} ⌊ \frac{{F}_{AD} ( {λ}_{D}^{ex} {λ}_{A}^{em} )}{{F}_{A} ( {λ}_{D}^{ex} {λ}_{A}^{em} )} - 1 ⌋ ( \frac{1}{{f}_{A}} ) \qquad ( eq . C )$$

where

$${ϵ}_{A} ( {λ}_{D}^{ex} ) and {ϵ}_{D} ( {λ}_{D}^{ex} )$$

are the extinction coefficients, at the donor's excitation wavelength, of the acceptor and donor, respectively. f_{A} is the fraction of acceptor in complex with the donor. This method for calculation of FRET efficiency requires that the donor does not emit at the acceptor's emission wavelength, a criterion not met by CFP and YFP as donor-acceptor pairs.

2. Microscopic Detection of FRET

Despite its promise for providing quantitative data on molecular behavior inside cells, FRET microscopy has been largely qualitative, or limited to a single measurement per cell. Most microscopic measurements of FRET yield a signal, in arbitrary units, that represents increased acceptor fluorescence due to FRET (sensitized emission). This is typically obtained in a fluorescence microscope using three combinations of filters: donor excitation plus donor emission

$$( {λ}_{ex}^{D} {λ}_{em}^{D} ) ,$$

acceptor excitation plus acceptor emission

$$( {λ}_{ex}^{A} {λ}_{em}^{A} ) ,$$

and donor excitation plus acceptor emission

$$( {λ}_{ex}^{D} {λ}_{em}^{A} ) ;$$

producing the corresponding fluorescence images I_{D}, I_{A} and I_{F}, respectively. I_{D} and I_{A} must discriminate donor and acceptor fluorescence, with negligible transmission of one fluorophore into the other's filter set. However, for many FRET pairs, including CFP and YFP, I_{F} often contains signal due to spectral overlap of the donor and acceptor emissions, even for mixtures of uncomplexed donor and acceptor that do not exhibit FRET. When FRET is detected as sensitized acceptor emission, I_{F} increases, I_{D} decreases and I_{A} remains unchanged. For unlinked donors and acceptors, whose stoichiometry varies widely between and within cells, FRET from donor-acceptor complexes is usually reported as the increase in I_{F}, after subtracting non-FRET signals in I_{F} due to free donor and acceptor. Image processing algorithms then normalize this corrected FRET signal for total fluorescence intensity and pathlength. Examples include FRETN (Gordon, G. W. et al. (1998) Biophys. J. 74:2702-2713) and N_{FRET} (Xia, Z., and Y. Liu (2001) Biophys. J. 81:2395-2402), which are expressed as:

$$FRETN = \frac{{I}_{F} - α {I}_{A} - β {I}_{D}}{{I}_{A} \times {I}_{D}} and {N}_{FRET} = \frac{{I}_{F} - α {I}_{A} - β {I}_{D}}{\sqrt{{I}_{A} \times {I}_{D}}}$$

(the coefficients a and P are explained below). FRETN has been shown to be intensity dependent and is consequently a misleading indicator of FRET (Xia, Z., and Y. Liu (2001) Biophys. J. 81:2395-2402). However, N_{FRET} provides a ratiometric method for detection of FRET inside cells, albeit one with weak analytical power. Imaging unlinked probes using N_{FRET} can indicate where FRET is occurring inside cells, but it does not quantify FRET efficiency (E) or the fractions of donor or acceptor molecules in complex (f_{D} and f_{A}, respectively).

The complications of interpreting FRET from unlinked chimeras have been compensated for by the development of linked biosensors (Miyawaki, A. et al. (1997) Nature 388:882-887), in which the ratio of CFP to YFP is fixed. Fluorophores are linked together by protein domains that change donor-acceptor distances upon analyte binding or covalent modification (Miyawaki, A. O. et al. (1999) Proc. Nat. Acad. Sci. U.S.A. 96:2135-2140; and Ting, A. Y. et al. (2001) Proc. Natl. Acad. Sci. USA 98:15003-15008). The changes in E due to intramolecular rearrangements can be detected by the ratio I_{F}/I_{D} (I_{A} is usually not measured for biosensors). However, biosensors are difficult to create, and since they are not intrinsic elements of signaling pathways, they may miss many of the spatial dynamics obtainable using fluorescent chimeras of component molecules. Moreover, linked biosensors typically exhibit a limited range of FRET signals, because their open and closed configurations change E only slightly.

3. Flow Cytometric Detection of FRET

A flow cytometer developed by Chan et al. (Chan, F. K.-M. et al. (2001) Cytometry 44) detected FRET between CFP- and YFP-tagged cell surface receptors. A BD Bioscience FACSVantage SE cell sorter was adapted for measuring the flow cytometric equivalents of I_{D}, I_{A} and I_{F}. FRET was detected using compensation algorithms to subtract non-FRET fluorescence from I_{F}. Although the measurements indicated detection of FRET, it was not clear that non-FRET acceptor fluorescence had been corrected fully. Moreover, an independent photobleaching step was required for quantifying the FRET signals. Proper development of flow cytometry for FRET requires characterization using FRET-positive standards, such as linked and unlinked CFP and YFP (or citrine, a pH-insensitive YFP), as described herein.

4. Advantages of FRET Stoichiometry

The current methods described above for quantification of intracellular FRET miss many parameters of the underlying interactions. The present invention provides new methods for analysis of FRET inside cells, which uses the same component signals as other methods (I_{D}, I_{A} and I_{F}) to quantify the stoichiometry of formation of complexes (described in greater detail below); this method is referred to as “FRET stoichiometry.” FRET stoichiometry allows rapid and repeatable quantitative measurement of the binding interactions between proteins or other molecules labeled with donor and acceptor fluorophores, including but not limited to CFP, GFP, YFP, and citrine, and eliminates the need for photobleaching to quantify donor quenching by FRET.

The ability to measure the stoichiometry of interacting fluorescent chimeras opens new areas of intracellular chemistry to quantitative study. Application of FRET stoichiometry to fluorescent chimeras that are intrinsic components of signaling pathways allows quantitative analysis of the spatially organized chemistries that constitute signal transduction. For example, unlinked CFP and citrine chimeras should exhibit greater dynamic range than linked biosensors. Moreover, FRET stoichiometry can be generalized to the study of multi-molecular interactions and membrane associations. FRET stoichiometry therefore finds use in studies of the behaviors of molecules in their native pathways (examples of such behaviors are described in Kraynov, V. S. et al. (2000) Science 290:333-337; and Janetopoulos, C. et al. (2001) Science 291:2408-2411) and the binding dynamics of membrane localized proteins and microdomains (8 Zacharias, D. A. et al. (2002) Science 296:913-916).

FRET stoichiometry is improved by development of methods for measuring E_{C}, the characteristic FRET efficiency of a particular bimolecular interaction. Knowing E_{C}, one can measure f_{D} and f_{A}, terms that provide fundamental parameters about equilibrium distributions of donor and acceptor, respectively.

The present invention also provides methods of adapting FRET stoichiometry to flow cytometry, which greatly expands its analytical potential. The ability to measure equilibrium distributions of CFP and citrine-labeled proteins in many cells at a time facilitates rigorous statistical analyses of intracellular chemistries. The present invention also provides methods of utilizing FRET stoichiometry for high throughput screening. Moreover, the present invention provides systems and devices for carrying out the methods of FRET stoichiometry, which include but are not limited to microscopes, flow cytometers, and high throughput screening systems and devices.

B. Preliminary Investigations

In some embodiments, the present invention provides stoichiometric methods that use three microscopic fluorescence images or intensities to measure FRET efficiency, the relative concentrations of donor and acceptor, and the fractions of donor and acceptor in complex in living cells. The methods were developed from the theory as described below, and both the theory and methods are supported by modeling, and by microscopic measurements of fluorescence from CFP, citrine, and linked CFP-citrine fusion protein, in solutions and inside cells.

1. Theory and Modeling of FRET Stoichiometry

FRET stoichiometry employed the same measurements as previously described by others (Youvan, 1997; Gordon et al., 1998; Xia and Liu, 2001; Erickson et al., 2001). Images for microscopic detection of FRET were obtained using three combinations of excitation and emission filters: donor excitation plus donor emission, acceptor excitation plus acceptor emission, and donor excitation plus acceptor emission, producing the corresponding fluorescence intensities I_{D}, I_{A} and I_{F}. I_{D} and I_{A} discriminated donor and acceptor fluorescence with negligible excitation or emission of one fluorophore in the other's filter combination.

In steady state measurements, FRET manifests itself as a loss of fluorescence from the donor and an increase in fluorescence from the acceptor. Thus, for a fixed concentration of molecules, FRET results in an increase in I_{F}, a decrease in I_{D} and no change in I_{A} (as shown in FIGS. 1A and B). This simple relationship is complicated by the overlapping excitation and emission spectra of most fluorophores, including the fluorescent proteins. I_{F} often contains signal due to spectral overlap of the donor and acceptor emissions, even for mixtures of uncomplexed donor and acceptor that do not exhibit FRET. Under experimental conditions, the concentrations of donor and acceptor vary widely between and within cells due to differences in localization and expression levels. This means that the intensities I_{D}, I_{A} and I_{F} depend on the relative concentrations of donors, acceptors and interacting molecules (stoichiometry) and the efficiency at which energy is transferred from the donor to the acceptor (FRET efficiency) (FIG. 7C). FIG. 7C shows that the interactions between donor, acceptor, and donor-acceptor complexes can be measured by four parameters: the efficiency of energy transfer (E) of donor-acceptor complexes, the fraction of acceptor molecules in complex (f_{A}), the fraction of donor molecules in complex (f_{D}) and the ratio of total acceptor to total donor (R).

The interrelationship between the three intensities, I_{D}, I_{A}, and I_{F}, can be used to measure FRET efficiency and the stoichiometry of donor and acceptor molecules in complex (FIG. 1C). These intensities depend on the fraction of interacting molecules (stoichiometry) and FRET efficiency (E). It has been discovered that all information about stoichiometry and efficiency is contained in the three images as the FRET-dependent fluorescence from the donor ID, the FRET-independent fluorescence from the acceptor I_{A}, and the mixture of donor, acceptor, and FRET fluorescence I_{F}.

FRET stoichiometry measures FRET efficiencies and the fractions of donor and acceptor labeled molecules in complex for donor-acceptor pairs where non-FRET acceptor fluorescence is detectable in I_{F}.

1.a. Developing the Equations.

Imaging FRET Efficiency by Sensitized Acceptor Emission.

A goal of live cell imaging is to collect multiple fluorescence images as a cell responds to a stimulus. To optimize this measurement, exposure times should be minimized to reduce photobleaching, to maintain cell viability, and to collect data at frequent intervals. Others have used a fluorescence microscope that collects three images through excitation and emission bandpass filters (Gordon et al. (1998) Biophys J. 74:2702-13; Xia and Liu (2001) Biophys J. 81:2395-402). These three images are:

donor excitation and donor emission,

$$F ( {λ}_{D}^{ex} {λ}_{D}^{em} )$$

or I_{D};

acceptor excitation and acceptor emission,

$$F ( {λ}_{A}^{ex} {λ}_{A}^{em} )$$

or I_{A};

and donor excitation and acceptor emission,

$$F ( {λ}_{D}^{ex} {λ}_{A}^{em} )$$

or I_{F}.

A first assumption is that I_{D} and I_{A} generally discriminate donor and acceptor fluorescence, with negligible transmission of one fluorophore into the other's filter set. That is,

$$\begin{matrix}{F}_{A} ( {λ}_{D}^{ex} {λ}_{D}^{em} ) = 0 & ( D ) \\ {F}_{D} ( {λ}_{A}^{ex} {λ}_{A}^{em} ) = 0 & ( E )\end{matrix}$$

A second assumption is that the contributions of excitation light or fluorescence emission can be propagated from one filter combination to another by scalar factors.

To satisfy equation (C) in the microscope,

$${F}_{AD} ( {λ}_{D}^{ex} {λ}_{A}^{em} ) and {F}_{A} ( {λ}_{D}^{ex} {λ}_{A}^{em} )$$

should be obtained while correcting for donor fluorescence spectral contamination of the acceptor's emission. Secondly,

$${F}_{A} ( {λ}_{D}^{ex} {λ}_{A}^{em} ) ,$$

the acceptor fluorescence in the absence of donor, should be determined even in the presence of donor. Provided the acceptor fluorescence is not modified by the physical interaction with the donor-labeled molecule and the donor is not excited at the acceptor's excitation (E) then,

$${F}_{AD} ( {λ}_{A}^{ex} {λ}_{A}^{em} ) = {F}_{A} ( {λ}_{A}^{ex} {λ}_{A}^{em} ) . \qquad ( F )$$

Given (F), and that the emission of the acceptor due to excitation at one wavelength is proportional to the emission at another excitation wavelength, the fluorescence of the acceptor alone can be determined in the presence of donor,

$${F}_{A} ( {λ}_{D}^{ex} {λ}_{A}^{em} ) = α {F}_{AD} ( {λ}_{A}^{ex} {λ}_{A}^{em} ) = α {I}_{A} \qquad ( G )$$

where α is measured in a sample containing only acceptor as:

$$α = \frac{{F}_{A} ( {λ}_{D}^{ex} {λ}_{A}^{em} )}{{F}_{A} ( {λ}_{A}^{ex} {λ}_{A}^{em} )} . \qquad ( H )$$

In many cases the fluorescence emission of the donor overlaps with the emission of the acceptor (as with CFP and citrine). Therefore, when both donor and acceptor are present, the signal collected in the acceptor emission with donor excitation,

$$F ( {λ}_{D}^{ex} {λ}_{A}^{em} )$$

or I_{F}, consists of fluorescence from both acceptor and donor:

$$F ( {λ}_{D}^{ex} {λ}_{A}^{em} ) = {F}_{AD} ( {λ}_{D}^{ex} {λ}_{A}^{em} ) + {F}_{DA} ( {λ}_{D}^{ex} {λ}_{A}^{em} ) = {I}_{F} \qquad ( I )$$

The donor fluorescence contribution to IF can be determined from the donor image (I_{D}) as:

$${F}_{DA} ( {λ}_{D}^{ex} {λ}_{A}^{em} ) = β {F}_{DA} ( {λ}_{D}^{ex} {λ}_{D}^{em} ) = β {I}_{D} \qquad ( J )$$

Where the correction factor β comes from independent measurements of donor fluorescence in the FRET filter set relative to donor fluorescence in the donor filter set, absent acceptor:

$$β = \frac{{F}_{D} ( {λ}_{D}^{ex} {λ}_{A}^{em} )}{{F}_{D} ( {λ}_{D}^{ex} {λ}_{D}^{em} )} \qquad ( K )$$

Substituting equations (G), (I), and (J) into the sensitized emission equation (C) gives:

$$E = \frac{{ϵ}_{A} ( {λ}_{D}^{ex} )}{{ϵ}_{D} ( {λ}_{D}^{ex} )} [ \frac{F ( {λ}_{D}^{ex} {λ}_{A}^{em} ) - β {F}_{DA} ( {λ}_{D}^{ex} {λ}_{D}^{em} )}{α {F}_{A} ( {λ}_{A}^{ex} {λ}_{A}^{em} )} - 1 ] ( \frac{1}{{f}_{A}} ) \qquad \text{(L)}$$

These fluorescence contributions can be intensities or images of intensities collected through various combinations of excitation and emission filters. Thus, equation (L) can be expressed as:

$$E = γ [ \frac{{I}_{F} - β {I}_{D}}{α {I}_{A}} - 1 ] ( \frac{1}{{f}_{A}} ) \qquad \text{(M)}$$

γ is the scalar relating the absorbance of the acceptor to absorbance of the donor at the donor's excitation (Lakowicz (1999) Principles of fluorescence spectroscopy. Kluwer Academic/Plenum, New York):

$$γ = \frac{{ϵ}_{A} ( {λ}_{D}^{ex} )}{{ϵ}_{D} ( {λ}_{D}^{ex} )} \qquad \text{(N)}$$

Determination of f_{A} by FRET Stoichiometry.

For a bimolecular binding event, the specific orientations and distances between the acceptor and donor fluorophores will be the same under a given set of conditions. That is, for a given bimolecular interaction, there is a characteristic efficiency of energy transfer E_{C}. Even if the bimolecular interaction results in a distance or orientation distribution between the donor and acceptor dipoles, E_{C} will still be specifically described by that binding event. Provided E_{C} can be determined, by fluorescence lifetime or other methods, then f_{A} can be measured as:

$${f}_{A} = \frac{[ C ]}{[ {A}_{T} ]} = γ [ \frac{{I}_{F} - β {I}_{D}}{α {I}_{A}} - 1 ] ( \frac{1}{{E}_{C}} ) \qquad \text{(O)}$$

If not, then an apparent efficiency of transfer to the acceptor (E_{A}) can still be measured. This efficiency is the product of the two unknowns, E and f_{A}, and is still quantitative in that changes in E_{A} reflect real changes in the number of acceptor labeled molecules in complex

E_{A}=Ef_{A} (P).

Determination of f_{D} by FRET Stoichiometry.

The sensitized emission fluorescence from the acceptor can also be used to determine the fluorescence of the donor in the unquenched state. Provided the only effect of the binding event on the acceptor and donor fluorescence is energy transfer, then conservation of energy dictates that the sensitized emission from the acceptor should be proportional to the loss of fluorescence from the donor. The fluorescence emitted by the acceptor can be thought of as the fluorescence due to direct excitation of the acceptor

$${F}_{A} ( {λ}_{D}^{ex} {λ}_{A}^{em} )$$

plus the excitation of the acceptor due to energy transfer

$${F}_{T} ( {λ}_{D}^{ex} {λ}_{A}^{em} ) .$$

Incorporating this into (I) gives:

$$F ( {λ}_{D}^{ex} {λ}_{A}^{em} ) = {F}_{AD} ( {λ}_{D}^{ex} {λ}_{A}^{em} ) + {F}_{DA} ( {λ}_{D}^{ex} {λ}_{A}^{em} ) = {F}_{A} ( {λ}_{D}^{ex} {λ}_{A}^{em} ) + {F}_{T} ( {λ}_{D}^{ex} {λ}_{A}^{em} ) + {F}_{DA} ( {λ}_{D}^{ex} {λ}_{A}^{em} ) \qquad \text{(Q)}$$

Combining (Q) with (G) and (J), the fluorescence from the acceptor due to energy transfer is:

$${F}_{T} ( {λ}_{D}^{ex} {λ}_{A}^{em} ) = F ( {λ}_{D}^{ex} {λ}_{A}^{em} ) - α {F}_{AD} ( {λ}_{A}^{ex} {λ}_{A}^{em} ) - β {F}_{DA} ( {λ}_{D}^{ex} {λ}_{D}^{em} ) \qquad \text{(R)}$$

The total quantity of fluorescence emitted from the unquenched donor can be obtained as:

$${F}_{D} ( {λ}_{D}^{ex} {λ}_{D}^{em} ) = {F}_{T} ( {λ}_{D}^{ex} {λ}_{A}^{em} ) \frac{ξ}{γ} + {F}_{DA} ( {λ}_{D}^{ex} {λ}_{D}^{em} ) \qquad \text{(S)}$$

where ξ corrects for the quantum yield of the acceptor and the quantity of photons that are collected in the acceptor emission relative to those that would have been collected in the donor emission if there were no energy transfer. Combining (S) with the definition of efficiency for energy transfer from the donor (B), E from the donor fluorescence is obtained:

$$E = [ 1 - \frac{{F}_{DA} ( {λ}_{D}^{ex} {λ}_{A}^{em} )}{{F}_{T} ( {λ}_{D}^{ex} {λ}_{A}^{em} ) \frac{ξ}{γ} + {F}_{DA} ( {λ}_{D}^{ex} {λ}_{A}^{em} )} ] ( \frac{1}{{f}_{D}} ) \qquad \text{(T)}$$

Written in terms of the three acquired images this becomes:

$$E = [ 1 - \frac{{I}_{D}}{( {I}_{F} - α {I}_{A} - β {I}_{D} ) \frac{ξ}{γ} + {I}_{D}} ] ( \frac{1}{{f}_{D}} ) \qquad \text{(U)}$$

If the characteristic efficiency, E_{C}, is known then f_{D} can be determined as

$${f}_{D} = \frac{[ C ]}{[ {D}_{T} ]} = [ 1 - \frac{{I}_{D}}{( {I}_{F} - α {I}_{A} - β {I}_{D} ) \frac{ξ}{γ} + {I}_{D}} ] ( \frac{1}{{E}_{C}} ) \qquad ( V )$$

If E_{C} is unknown, an apparent efficiency (E_{D}) can be determined as

E_{D}=Ef_{D}. (W)

Obtaining R

The absolute ratio of acceptor molecules to donor molecules can be determined as the ratio of acceptor fluorescence (independent of FRET) to that of the corrected donor fluorescence by calculating the ratio of equations (V) to (O):

$$R = \frac{[ {A}_{T} ]}{[ {D}_{T} ]} = ( \frac{ξ}{{γ}^{2}} ) \frac{α {I}_{A}}{( {I}_{F} - α {I}_{A} - β {I}_{D} ) \frac{ξ}{γ} + {I}_{D}} \qquad ( X )$$

This equation is the indicator of the mole fraction of total acceptors to total donors per pixel.

2.a. Acceptor Stoichiometry.

The first equation for FRET stoichiometry (derived from eq. C) measures FRET efficiencies and the fractions of acceptor-labeled molecules in complex, using donor-acceptor pairs in which non-FRET acceptor fluorescence is detectable in I_{F}. For a bimolecular interaction, the efficiency of energy transfer is calculated from sensitized acceptor emission as

$$E = γ ⌊ \frac{( {I}_{F} - β {I}_{D} )}{( α {I}_{A} )} - 1 ⌋ ( \frac{1}{{f}_{A}} ) \qquad \text{(eq. 1; eq. M above)}$$

where E is the FRET efficiency of the donor-acceptor complex, f_{A} is the fraction of acceptor in complex with donor, α and β are independently measured proportionality constants for acceptor and donor fluorescence, respectively (i.e., α=I_{F}/I_{A} when only acceptor is present, and β=I_{F}/I_{D} when only donor is present), and γ is the ratio of the extinction coefficients of the acceptor to the donor, measured at the donor's excitation wavelength (Lakowicz, J. R. (1999) Principles of Fluorescence Spectroscopy, 2nd ed. Kluwer Academic/Plenum, New York).

For cellular measurements, the fraction of acceptor in complex is generally not known. Since energy transfer is dependent on both the distance and orientation of the transition dipole moments between the two fluorophores, molecular interactions for a specific pair of donor and acceptor molecules will result in a characteristic FRET efficiency (E_{C}) for that interaction. This can be thought of as a distance and orientation distribution for which E_{C} describes the mean of the distribution. If E_{C} for a given donor-acceptor pair can be determined from independent measurements, then the fraction of acceptor-labeled molecules in complex (f_{A}) can be obtained:

$${f}_{A} = γ ⌊ \frac{{I}_{F} - β {I}_{D}}{α {I}_{A}} - 1 ⌋ ( \frac{1}{{E}_{C}} ) \qquad \text{(eq. 2; eq. O above)}$$

If E_{C} is not known, or if the interaction involves multiple acceptors, then an apparent efficiency (E_{A}) can be measured which is the product of E_{C} and the fraction of acceptor in complex:

$${E}_{A} = {E}_{C} {f}_{A} = γ ⌊ \frac{{I}_{F} - β {I}_{D}}{α {I}_{A}} - 1 ⌋ \qquad ( eq . 3 ; eq . P above )$$

Additionally, an apparent efficiency (E_{A}) can be measured which is the product of the true efficiency and the fraction of acceptor in complex (similar to E_{EFF} from Erickson et al. (2001) (Neuron. 31:973-85):

$${E}_{A} = {Ef}_{A} = γ [ \frac{{I}_{F} - β {I}_{D}}{α {I}_{A}} - 1 ] \qquad \text{(eq. 3)}$$

Importantly, E_{A} is still proportional to the fraction of acceptor in complex and can be used to measure changes in the fraction of molecules in complex.

The present invention provides methods and devices to determine E_{C}, as well as other coefficients of FRET stoichiometry.

2.b. Donor stoichiometry. The fraction of donor in complex (f_{D}) can also be obtained from I_{D}, I_{A}, and I_{F} by estimation of donor fluorescence in the absence of FRET (derived from eq. B). Others have determined this by measuring the increase in donor fluorescence after photobleaching the acceptor (Kenworthy, A. K. et al. (2000) Mol. Biol. Cell 11:1645-1655; and Zacharias, D. A. et al. (2002) Science 296:913-916), but this method is slow and does not allow for repeated measurements of the same cell. Instead, it has been determined that the donor fluorescence lost due to FRET can be estimated by independently calibrating the extent to which stimulated acceptor emission increases as donor fluorescence decreases (Tron, L. et al. (1984) Biophys J. 45:939-46; and Gordon, G. W. et al. (1998) Biophys J. 74:2702-13. Because the chromophores of the fluorescent proteins are shielded from perturbations of the local environment, it is likely that dipolar energy transfer is the dominant mechanism for the decrease in fluorescence of the donor (Tsien, R. Y. (1998) Biochem. 67:509-544). Accordingly, total donor fluorescence can be measured as I_{D} plus the corrected sensitized acceptor emission, and this can then be used to calculate the fraction of donor in complex:

$${f}_{D} = ⌊ 1 - \frac{{I}_{D}}{( {I}_{f} - α {I}_{A} - β {I}_{D} ) \frac{ξ}{γ} + {I}_{D}} ⌋ ( \frac{1}{{E}_{C}} ) \qquad \text{(eq. 4; eq. D above)}$$

where ξ accounts for the difference between the shape of the acceptor and donor emission spectra and the quantum efficiency of the acceptor. In other words, ξ relates the quantity of sensitized emission (salmon colored area of FIG. 7A) detected in I_{F} relative to the donor fluorescence (cyan colored area of FIG. 7A). Thus, ξ accounts for the fraction of sensitized acceptor emission detected in I_{F} relative to the fraction of donor fluorescence not transferred by FRET. For fluorescent protein acceptors such as citrine, the chromophore is well protected and should result in a quantum yield that is independent of environment; thus, ξ should be a constant for proteins labeled with CFP and YFP. Given the complexities in wavelength transmission in the microscope as well as the detector response, ξ was determined empirically, rather than calculated.

When E_{C} is unknown, the apparent donor efficiency E_{D} can be determined as

$${E}_{D} = {E}_{C} {f}_{D} = ⌊ 1 - \frac{{I}_{D}}{( {I}_{F} - α {I}_{A} - β {I}_{D} ) \frac{ξ}{γ} + {I}_{D}} ⌋ \qquad \text{(eq. 5; eq. W above)}$$

or the apparent donor efficiency can be determined as the product of the true efficiency and the fraction of donor in complex:

$${E}_{D} = {Ef}_{D} = [ 1 - \frac{{I}_{D}}{( {I}_{F} - α {I}_{A} - β {I}_{D} ) \frac{ξ}{γ} + {I}_{D}} ] \qquad ( 5 )$$

2.c. Donor-acceptor ratios. Finally, estimating total donor fluorescence in the absence of FRET allows determination of the concentration of R, the ratio of acceptor [A] to donor [D]:

$$R = \frac{[ {A}_{T} ]}{[ {D}_{T} ]} = ( \frac{ξ}{{γ}^{2}} ) \frac{α {I}_{A}}{( {I}_{F} - α {I}_{A} - β {I}_{D} ) \frac{ξ}{γ} + {I}_{D}} \qquad ( eq . 6 ; same as eq . X above )$$

FRET stoichiometry corrects for variable sample thickness, and therefore provides, at each pixel of the image, the relative concentrations of donor, acceptor and complex. For bimolecular interactions, f_{A} and f_{D} will range from 0-1, indicating the fraction of acceptor- or donor-labeled molecules participating in a molecular complex. R equal to 1 indicates that equal mole fractions of donors and acceptors are present in the image pixel, R greater than 1 or less than 1 indicates an excess of either acceptor or donor, respectively.

Measuring the complete stoichiometry, R, f_{A} and f_{D} (or E_{A} and E_{D}, when E_{C} is unknown) is particularly useful for obtaining information about the numbers of interacting molecules as well as identifying the limiting binding partner of an interaction.

3. Summary

FRET stoichiometry applies three essential equations to measure interactions between fluorescent proteins inside living cells.

1. f_{A}: A first equation determines the fraction of acceptor molecules in complex with donor molecules.

a. Provided E_{C} can be determined, by fluorescence lifetime or other methods, then f_{A} can be measured as:

$${f}_{A} = \frac{[ C ]}{[ {A}_{T} ]} = γ [ \frac{{I}_{F} - β {I}_{D}}{α {I}_{A}} - 1 ] ( \frac{1}{{E}_{C}} ) \qquad ( 2 )$$

where C represents the amount of complex, and AT represents the total amount of the acceptor.

b. If E_{C} can not be determined, then an apparent efficiency of transfer to the acceptor (E_{A}) can still be measured. This efficiency is the product of the two unknowns, E and f_{A}, and is still quantitative in that changes in E_{A} reflect real changes in the number of acceptor labeled molecules in complex.

E_{A}=Ef_{A} (3)

2. f_{D}: A second equation determines the fraction of donor molecules in complex with acceptor molecules by estimating the donor fluorescence lost due to energy transfer.

a. If the characteristic efficiency, E_{C}, is known then f_{D} can be determined as

$${f}_{D} = \frac{[ C ]}{[ {D}_{T} ]} = [ 1 - \frac{{I}_{D}}{( {I}_{F} - α {I}_{A} - β {I}_{D} ) \frac{ξ}{γ} + {I}_{D}} ] ( \frac{1}{{E}_{C}} ) \qquad ( 4 )$$

where C represents the amount of complex, and DT represents the total amount of the donor.

b. If EC is unknown, an apparent efficiency (E_{D}) can be determined as

E_{D}=Ef_{D}. (5)

3. R: A third equation obtains the ratio of total acceptor to total donor molecules.

$$R = \frac{[ {A}_{T} ]}{[ {D}_{T} ]} = ( \frac{ξ}{{γ}^{2}} ) \frac{α {I}_{A}}{( {I}_{F} - α {I}_{A} - β {I}_{D} ) \frac{ξ}{γ} + {I}_{D}} \qquad ( 6 )$$

Application of these equations involvew first, calibration of the microscope to determine α, β, γ and ξ; and second, determination of E_{C} for a particular bimolecular interaction. When E_{C} is determined, these constants, together with the fluorescence images or intensities I_{A}, I_{D} and I_{F}, can then be used in the equations above to calculate the quantities f_{A}, f_{D} and R for that interaction inside cells. Alternatively, if E_{C} is unknown or inappropriate (as described further below) to the chemistry being studied, then the quantities E_{A}, E_{D} and R can be measured. The quantities E_{A} and E_{D} are proportional to the fraction of acceptors or donors in complex, respectively, and can be used to measure changes in the fraction of molecules in complex.

The applicability of FRET stoichiometry was established in three ways. First, the equations were examined and compared to other methods using mathematical modeling. The modeling showed that the terms E_{A} and E_{D} scaled linearly with FRET efficiency and that the equations for f_{A} and f_{D} could accurately distinguish conditions of excess donor and excess acceptor, in contrast to all other methods. Second, the equations were applied to microscopic images of mixtures of purified CFP, citrine and linked CFP-Cit. The solution measurements showed that f_{A} and f_{D} correctly reported fractions of acceptor and donor, respectively, as well as the true ratios of total acceptor to total donor. Third, the equations were applied to cells expressing various mixtures of linked and unlinked fluorophores. Although the intracellular ratios of CFP, citrine and linked CFP-Cit were unknown due to the variability of gene delivery and protein expression, the aggregate distributions of f_{A}, f_{D} and R in the measured populations of cells indicated that the measured stoichiometries were correct.

An important feature of FRET stoichiometry is its application of characteristic FRET efficiency, E_{C}, to discriminate efficiency and fraction. The use of E_{C} to discriminate fractions of bound molecules is appropriate when the binding interaction gives rise to a reproducible efficiency. Multi-valent interactions or FRET between molecules with multiple fluorophores attached to each molecule may add additional levels of complexity. Nonetheless, for bimolecular interactions, designating a characteristic value for the mean FRET efficiency of donor-acceptor complexes allowed stoichiometric measurement of reaction parameters: the ratios of bound and free donor and acceptor chimeras. E_{C} is most easily measured from linked constructs, such as CFP-Cit, in which all CFP and citrine are in complex (and both f_{A} and f_{D} equal one). E_{C} of linked CFP-Cit was measured using fluorescence lifetimes of free CFP and the CFP of linked CFP-Cit, then applied to determine γ and ξ. For stoichiometry of bimolecular interactions between unlinked fluorophores, it is contemplated that donor-acceptor complexes will also have an E_{C}, which will have to be determined from equilibrium mixtures of free donor, free acceptor and donor-acceptor complexes. E_{C} for unlinked fluorophores may be measurable in living cells by fluorescence lifetime-based methods (e.g., using curve fitting of CFP fluorescence decays). Alternatively, E_{C} may be obtainable from either solution or expression measurements of various ratios of donor and acceptor, identifying E_{C} as the maximum observed E_{A} and E_{D} in a range of mixtures. However, even if the characteristic efficiency is not known, FRET stoichiometry can still be used to measure E_{A} and E_{D}; then if E_{C} for that interaction is determined at a later point, f_{A} and f_{D} can be inferred from the original data.

For some intracellular chemistries, however, FRET efficiency will vary over a wide range of values, without a characteristic FRET efficiency for the interaction. For example, CFP and citrine chimeras that bind to membrane phospholipids could exhibit FRET as a function of lipid density in the bilayer (Kenworthy et al. (2000) Mol Biol Cell. 11:1645-55; and Zacharias et al. (2002) Science. 296:913-6). In that case, E would be variable and fall over a wide range of values, and the terms f_{A} and f_{D} would not apply. Rather, the more general terms E_{A} and E_{D}, which incorporate both FRET efficiency and fractions of acceptor and donor in complex, would better describe the interactions. The utility of E_{A} was recognized in the earlier study of Erickson et al. (Erickson et al. (2001) Neuron. 31:973-85) whose term E_{EFF} was similar to E_{A}.

The other coefficients used to develop FRET stoichiometry were introduced in earlier studies. α and β correct for non-FRET fluorescence of acceptor and donor in the FRET filter set, and are applied here just as they have been in many prior studies (Gordon et al. (1998) Biophys J. 74:2702-13; Xia and Liu (2001) Biophys J. 81:2395-402; and Erickson et al. (2001) Neuron. 31:973-85). γ, the ratio of extinction coefficients for acceptor and donor, excited at the donor's excitation, is an important descriptor of the donor-acceptor pair, and has been previously applied to measure FRET by stimulated emission, both in solutions (Lakowicz (1999) Principles of fluorescence spectroscopy. Kluwer Academic/Plenum, New York) and in the microscope (Erickson et al. (2001) Neuron. 31:973-85). However, unlike previous methods for obtaining γ, the methods for FRET stoichiometry obtained γ by back-calculation from measured values of E_{C}, α, β, I_{A}, I_{D} and I_{F} collected directly in the microscope, for example, using linked and unlinked CFP and citrine. The present invention also develops and measures ξ for estimating the donor fluorescence lost due to FRET. Application of ξ was important for calculation of E_{D}, f_{D} and R, which are important stoichiometric measurements of donor concentrations. ξ allows measurement of donor participation in FRET complexes, and eliminates the need for acceptor photobleaching to determine the fraction of energy lost from the donor. A similar term was used in the derivations of Gordon et al. (1998) Biophys J 74:2702-13), although it was not applied or obtained in the microscope in that study.

The ability of FRET stoichiometry to measure R, the ratio of total acceptor to total donor, is valuable as a quantitative measure of relative concentrations even for molecules that do not exhibit FRET. For example, using a microscope calibrated for α, β, γ and ξ, the molar ratio of donor and acceptor fluorophores can be obtained inside a cell. For example, R facilitates studies of the relative local concentrations of CFP and citrine chimeras that do not associate with each other (i.e., no FRET) inside cells.

Fluorescent proteins are especially good fluorophores for live-cell FRET stoichiometry studies. A consideration in calculating E_{D} and f_{D} is whether other mechanisms contribute to the loss of donor fluorescence for a molecular interaction. Since the chromophores of the fluorescent proteins are buried in the core of a protein, it is likely that dipolar energy transfer (rather than exchange mechanism or polarity change) is the dominant mechanism for the decrease in fluorescence of the donor (Tsien (1998) Annu Rev Biochem. 67:509-44. Secondly, citrine (Griesbeck et al. (2001) J Biol Chem. 276:29188-94) removes the pH sensitivity of CFP/citrine energy transfer and is demonstrated here to have a much longer Forster distance than CFP/EYFP. Both of these properties are contemplated to improve FRET studies between fluorescent protein chimeras.

Complications of interpreting FRET data from fluorescent chimeras have been addressed by the development of linked biosensors (Miyawaki et al. (1997) Nature 388:882-7), in which CFP and YFP (or citrine) are linked together by protein domains that change donor-acceptor distances upon analyte binding or covalent modification (Miyawaki et al. (1999 Proc Natl Acad Sci USA. 96:2135-40; Ting et al. (2001) Proc Natl Acad Sci USA 98:15003-8). Although linked biosensors reduce concerns about local concentrations of donor and acceptor (f_{A} and f_{D} equal one), they are difficult to create. Moreover, because they are not intrinsic elements of signaling pathways, they may miss many of the spatial dynamics obtainable using fluorescent chimeras of component molecules. Finally, linked biosensors may exhibit a smaller dynamic range than unlinked probes, as the linked biosensors typically exhibit some FRET even in their most open conformation (Miyawaki et al. (1997) Nature 388:882-7; Ting et al. (2001) Nature 388:882-7).

The ability to measure the binding stoichiometry of interacting fluorescent chimeras opens new areas of intracellular chemistry to quantitative study. Understanding of molecular systems in the cell will require quantitative comparisons of molecular events in space and time. FRET stoichiometry provides several advantages. It measures the complete stoichiometry of fractions of acceptors in complex, donor in complex, and the ratio of donor molecules to acceptor molecules at each pixel in an image. Unlike previous biochemical and microscopic methods, FRET stoichiometry measures the location and stoichiometry of molecular interactions inside a living cell. Moreover, FRET stoichiometry can be generalized to the study of multi-molecular interactions and membrane associations.

Thus, preliminary studies indicate that FRET stoichiometry can extract substantially new information about bimolecular interactions inside cells. The measured quantities, fraction and efficiency, are physical parameters that are transferable not only from one molecular interaction to another, but also to other fluorescence technologies, such as confocal microscopy and flow cytometry, as described below. After calibration of instruments to determine α, β, γ and ξ, and determination of E_{C}, the quantities f_{A} and f_{D} can be obtained by measuring fluorescence corresponding to I_{A}, I_{D} and I_{F} for these devices. Extension of FRET stoichiometry to higher throughput modalities allows quantitative analysis of molecular interactions in populations of living cells.

II. Methods for Measuring Essential Coefficients of FRET Stoichiometry

As described above, FRET stoichiometry can be used to measure the fractions of donor- and acceptor-labeled molecules participating in a bimolecular interaction. Measurement of f_{A} and f_{D} for a particular molecular interaction between two labeled proteins involves knowledge of the characteristic FRET efficiency, E_{C}, of that donor-acceptor complex. For example, to study the stoichiometry of interactions between two proteins involved in signal transduction, CFP-labeled Rac and citrine-labeled PAK1, it is important to determine E_{C} for the CFP-Rac/citrine-PAK1 complex, which will nearly always be mixed with free CFP-Rac and citrine-PAK1.

Currently, E_{C} is measured in cells or solutions containing linked donor-acceptor; i.e., by measuring τ_{D} of CFP and τ_{DA} of linked CFP-Cit, then applying eq. A (as in FIG. 9A). To apply FRET stoichiometry to independent interacting molecules, a method is provided to determine E_{C} of donor-acceptor complexes at equilibrium conditions, in which only a fraction of the donors and acceptors are in complex. Once E_{C} for a particular interaction has been determined, it will not have to be measured again (i.e., f_{A} and f_{D} can be obtained using E_{C} as a constant), and can be applied to any instrument that can measure the other parameters of FRET stoichiometry (I_{F}, I_{D}, I_{A}, α, β, γ and ξ).

The method to determine E_{C} of donor-acceptor complexes at equilibrium conditions is premised upon measuring the rate at which energy is transferred from the donor to the acceptor. The development of the method to determine E_{C} of donor-acceptor complexes at equilibrium conditions then involves several phases. In the first phase, various linked probes are prepared, EC of those probes is measured by donor fluorescence lifetime (E_{C}(DFL)), then a method for obtaining E_{C} is tested by measuring energy transfer rate (E_{C}(ETR)). In the next phase, a method for determining a characteristic FRET efficiency (E_{C}) for unlinked, interacting chimeric proteins is developed.

In the first phase, described in this section, E_{C} is measured in solutions of CFP or linked CFP-Cit; i.e., by measuring the fluorescence lifetimes (τ) of CFP and of the CFP in linked CFP-Cit. This method, referred to as E_{C}(DFL), is inaccurate when free donors are present. Thus, the description below provides a method that can determine E_{C} of donor-acceptor complexes at equilibrium. E_{C} is obtained by measuring the rate of energy transfer (E_{C}(ETR)); the rate at which energy is transferred from the donor to the acceptor is described by the rate constant k_{T} and the natural donor fluorescence lifetime (τ_{D}⁻¹) (Lakowicz, J. R. (1999) Principles of Fluorescence Spectroscopy, 2nd ed. Kluwer Academic/Plenum, New York). k_{T} is an intrinsic descriptor of the energy transfer process, which is independent of the fraction of molecules participating in energy transfer. Therefore, if k_{T} can be measured, then E_{C} can be obtained when only a fraction of the donors or acceptors are in complex. This is the first description of a method to measure E_{C} of a bimolecular interaction in living cells.

k_{T}, and consequently E_{C}, is measured by combining FRET stoichiometry with fluorescence lifetime analysis. The strategy is to use E_{C} measured by donor fluorescence lifetime E_{C}(DFL) to calibrate various linked probes, (CFP-Cit₆, CFP-Cit₁₇ and CFP-Cit₃₀), then to develop and test the E_{C}(ETR) method using those E_{C}-calibrated probes and mixtures of free CFP and citrine. For E_{C}(DFL), τ_{D} is measured using CFP, and τ_{DA} using the various linked CFP-Cit constructs, then calculate

E_{C}=1−(τ_{DA}/τ_{D}) (A)

The longer linkers are contemplated to have lower E_{C}.

Knowing E_{C} for different linked constructs, γ and ξ are obtained by back-calculating from the equations for FRET stoichiometry. The same linked probes are then measured using time-resolved fluorescence measurements to determine E_{C} by energy transfer rate (ETR). Steady state measurement of I_{A} are obtained by using an argon laser as the excitation source. Solutions of proteins or cells in the microscope are illuminated with pulsed 436 nm excitation from a Ti:Sapphire laser, and their fluorescence decays collected by time-correlated single-photon counting. Liquid crystal power stabilizers hold each laser to a fixed power, thereby maintaining proportional illumination intensities. The data is processed using the IA obtained with the argon laser to isolate the fluorescence decay associated with the stimulated emission due to FRET (the salmon-colored portion of FIG. 7A). The slope of that decay, k_{T}, will allow calculation of E_{C}.

A plot of E_{C}(DFL) vs. E_{C}(ETR) shows correlation between the two methods for determining E_{C}. After determining E_{C} for the various linked constructs, both in vitro and in situ, the limits of detection for the E_{C}(ETR) method are measured in mixtures of linked constructs plus free CFP or citrine (as a way of mimicking equilibrium distributions of donor, acceptor and complex). The lowest ratio of complex to total fluorophore for which E_{C} can be measured accurately are then determined. In cells expressing linked CFP-Cit plus CFP, E_{C} vs. R is plotted. A range of R values in which E_{C} equals that measured from linked CFP-Cit alone are then defined.

1. Rationale for Measurement of E_{C} by Energy Transfer Rate (E_{C}(ETR)).

FRET efficiency is measurable as the rate at which energy is transferred from the donor to the acceptor, described by the rate constant k_{T} and the natural donor fluorescence lifetime (τ_{D}⁻¹) (Lakowicz, J. R. (1999) Principles of Fluorescence Spectroscopy, 2nd ed. Kluwer Academic/Plenum, New York):

$$E = \frac{{k}_{T}}{{τ}_{D}^{- 1} + {k}_{T}} . \qquad ( AA )$$

k_{T} is an intrinsic descriptor of the energy transfer process, and is dependent on factors that affect the dipole-dipole coupling, such as distance and orientation, but is independent of the fraction of molecules participating in energy transfer. Therefore, if k_{T} can be measured, then E_{C} can be obtained when only a fraction of the donors or acceptors are in complexes. Until now, there have been no attempts to measure E_{C} of a bimolecular interaction in living cells. The best current methods only determine an apparent efficiency, which combines both E_{C} and the fractions of donor or acceptor participating in FRET (analogous to E_{A} or E_{D}, eqs. 3 and 5)

k_{T} (and consequently E_{C}) is measured by combining FRET stoichiometry and fluorescence lifetime analysis. FRET stoichiometry uses I_{A} and I_{D} to isolate the sensitized acceptor emission component of I_{F}. Analogous processing is contemplated to be applicable to fluorescence decays of the component signals. In time-domain measurements of FRET from a mixture of donors, acceptors, and donor-acceptor complexes, the time-resolved signal I_{F}(t) is be a mixture of three intensity decays: the direct (non-FRET) excitation of the acceptor (time-resolved α I_{A}, or α I_{A}(t)), the emission of the donor (time-resolved βI_{D}, or βI_{D}(t)), and the sensitized emission of the acceptor due to FRET (time-resolved I_{SE}, or I_{SE}(t)).

I_{SE}(t) can be isolated from I_{F}(t) by subtraction of the contaminating donor decay and the directly excited acceptor decay. When FRET is present, the βI_{D}(t) component of I_{F}(t) will indicate a shortened fluorescence lifetime (relative to the non-FRET condition), αI_{A}(t) will be identical to the acceptor decay without FRET, and I_{SE}(t) will be present. The donor decay can be measured in the experimental sample by collecting the fluorescence decay in the I_{D} filter combination; e.g., I_{D}(t). The decay of directly excited acceptor, I_{A}(t), could be determined directly using a pulsed-source laser at 514 nm; alternatively, when that wavelength is not obtainable with the available laser, I_{A}(t) is instead determined indirectly. Since I_{A}(t) is independent of FRET, the acceptor decay can be measured beforehand using pure acceptor (or cells expressing acceptor only) at

$${λ}_{D}^{ex} {λ}_{A}^{em} ( {I}_{F} ) ;$$

to obtain a fluorescence decay termed I_{F}^{A}(t). Normalizing I_{F}^{A}(t) to 1 provides the shape of the acceptor decay (Î_{F}^{A}(t)). The amplitude of the acceptor decay in the sample containing donor-acceptor FRET pairs can be obtained in situ by measuring the total fluorescence intensity of the acceptor at its excitation maximum and emission maximum I_{A} (which is not a fluorescence decay; it is obtained with an argon laser, 514 nm). Combining Î_{F}^{A}(t) with I_{A} and the proportionality constant α (as defined for FRET stoichiometry) obtains an acceptor decay of the correct amplitude (i.e., αI_{A}(t)=αI_{A}×Î_{F}^{A}(t)). Subtraction of the decays corresponding to the directly excited acceptor (αI_{A}×Î_{F}^{A}(t), the inferred αI_{A}(t)) and the spectral contamination of the donor (βI_{D}(t)) from the emission at I_{F}(t) isolates the sensitized emission of the acceptor:

I_{SE}(t)=I_{F}(t)−βI_{D}(t)−(αI_{A}×Î_{F}^{A}(t)) (BB)

Thus, I_{SE}(t) can be determined in cells expressing CFP-citrine FRET pairs by combining measurements of fluorescence decays (I_{F}(t) and I_{D}(t)) and steady state fluorescence (I_{A}) with independently determined constants (α, β and Î_{F}^{A}(t)). I_{SE}(t) is not the rate of energy transfer, but the convolution of the rate at which the acceptor is excited by energy transfer (like a lamp function) and the lifetime of the excited state of the acceptor. As in typical lifetime analysis, deconvolution of I_{SE}(t) with the measured I_{F}^{A}(t) will yield the energy transfer excitation function of the acceptor:

_{FRET}(t)=I_{SE}(t) [symbol] ′I_{F}^{A}(t) (CC)

The mean rate constant for I_{FRET}(t) is k_{T}, which can be found by fitting I_{FRET}(t) to a sum of exponentials. I_{FRET}(t) is largely independent of the fraction of donors or acceptors participating in energy transfer, provided sufficient signal-to-noise ratio in the acquired data.

The novelty of this method for measurement of E_{C} by energy transfer rate (E_{C}(ETR)) is chiefly its exploitation of the overlapping spectra of donor and acceptor. Direct (non-FRET) fluorescence of acceptor in IF allows determination of α, which in turn allows I_{A}(t) to be measured indirectly.

An alternative approach obtains E_{C} from FRET-dependent changes in the donor fluorescence lifetime (E_{C}(DFL)). This is straightforward when all donor and acceptor are in complex, but is more complicated when only some of the fluorophores are in complex. Curve-fitting of the donor fluorescence decay can be used to correct for incomplete labeling of the donor with acceptor, by assuming some type of multi-exponential fitting function as follows:

$${I}_{DA} ( t ) = ( 1 - {f}_{D} ) {I}_{D}^{0} {\sum }_{i}^{} {α}_{0 i} exp ( \frac{- t}{{τ}_{Di}} ) + {f}_{D} {I}_{D}^{0} {\sum }_{i}^{} {α}_{0 i} exp ( \frac{t}{{τ}_{Di}} - {tk}_{Ti} ) \qquad ( DD )$$

However, curve-fitting is difficult when the amplitudes and decay constants are similar. It has been estimated that this method is only reliable when greater than 95% of the molecules are in complex (Lakowicz, J. R. (1999) Principles of Fluorescence Spectroscopy, 2nd ed. Kluwer Academic/Plenum, New York).

Therefore, development of the method involves first using E_{C}(DFL) to measure E_{C} of various linked probes (where all donor and acceptor are in complex), then to develop and test E_{C}(ETR) using those E_{C}-calibrated probes.

2. Measuring Characteristic FRET Efficiencies (E_{C}) for Linked CFP-Cit Probes.

a. Preparation of Linked CFP-Citrine Probes.

Development of E_{C}(ETR) and calibration of the microscopes and flow cytometers requires molecular FRET standards. The initial studies described above have indicated the utility of linked CFP-Cit for these purposes. Because the initial studies involved linked CFP-Cit of a single length, and because pairs with longer linkers are contemplated to have lower characteristic FRET efficiencies (E_{C}) than pairs with short linkers, linked CFP-citrine probes with different lengths of linker regions are prepared.

Using standard methods for expression of 6His-tagged proteins in E. coli, plasmids encoding CFP and citrine with linkers of 6 (CFP-Cit₆), 17 (CFP-Cit₁₇; this is the linked CFP-Cit already described above and in the Examples) and 30 amino acids (CFP-Cit₃₀) are prepared. Each kind of probe, as well as unlinked CFP and citrine, are expressed in bacteria and purified from bacterial lysates, using nickel affinity chromatography. These methods result in mg quantities of CFP, citrine and linked CFP-Cit₁₇ obtained. Purified proteins are characterized by using fluorescence lifetime analysis and spectral analysis.

Purified protein probes are coupled to calibration beads for flow cytometry. Proteins are covalently labeled with biotin (NHS-X-biotin, Pierce Chemical Co.), then reacted with streptavidin-coated calibration beads (Molecular Probes, Eugene, Oreg.) to produce beads coated with fluorescent proteins. Thus, CFP-beads, citrine-beads, CFP-Cit₆-beads, CFP-Cit₁₇-beads, CFP-Cit₃₀-beads, and beads with CFP plus citrine at levels that do not produce FRET (CFP/Cit-beads) are prepared. The labeled beads are characterized spectrophotometrically (as described below).

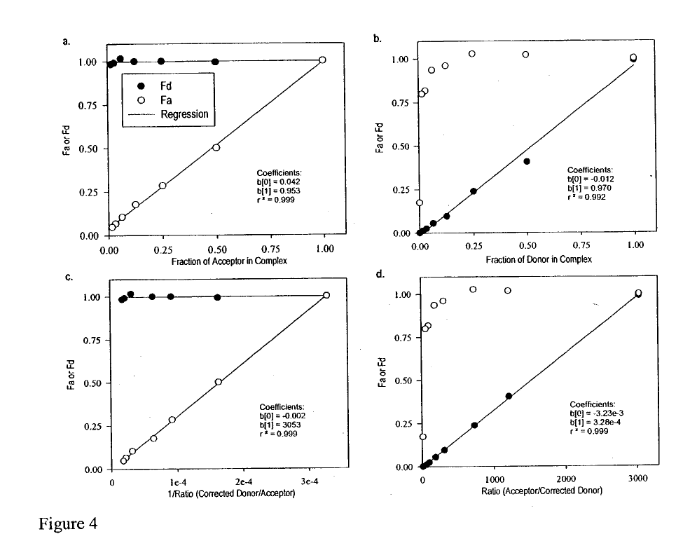

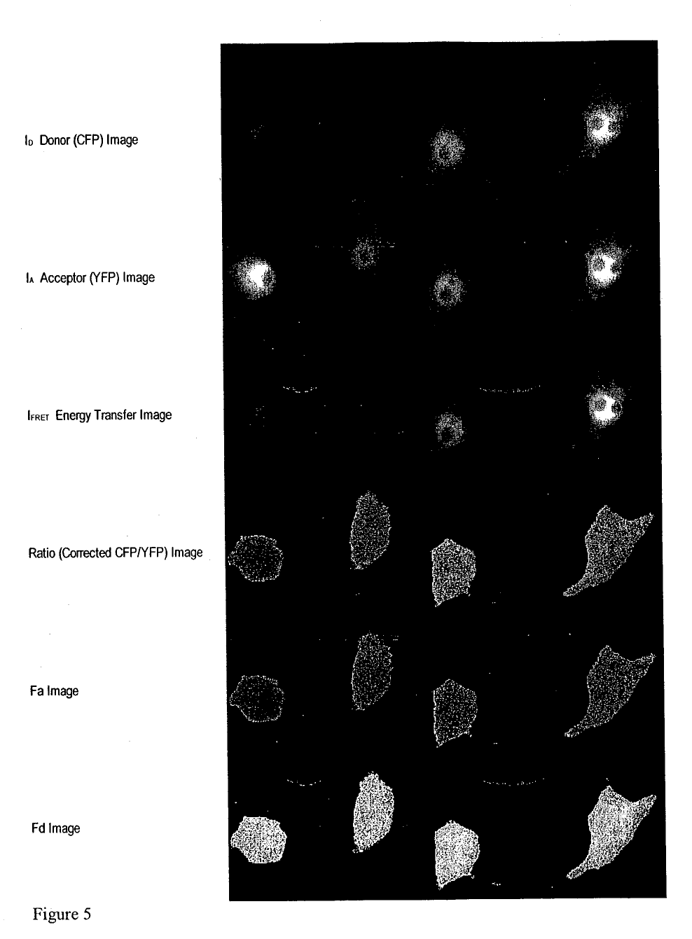

Probes are also incorporated into eukaryotic expression plasmids for expression in J774 macrophages (e.g. FIGS. 4 and 5). Transfections are performed using FuGene transfection reagents, (see, for example, Example 6).

b. Measuring α and β In Vitro and In Situ.

α and β are measured using laser excitation of three preparations: purified proteins in solution, proteins coupled to calibration beads, and proteins expressed in cells. Cells are transfected with DNA encoding either citrine or CFP, and the images IA, ID, and I_{F} are collected from 16 or more cells. α is calculated from shading-corrected images of cells expressing only citrine as α=I_{F}/I_{A}. β is determined similarly using cells expressing only CFP and measuring β=I_{F}/I_{D}. Measured values are compared to measurements from CFP-beads and solutions of purified CFP. α and β for the filter-based preliminary studies (described above) were 0.29 and 1.07, respectively, and similar values are expected to be obtained using the laser excitation for the E_{C}(ETR) measurements.

The apparatus consists of an inverted fluorescence microscope (Nikon TE-300), equipped with a temperature-controlled stage, shutters for trans- and epifluorescence illumination, filter wheels for both excitation and emission filters, dichroic mirrors that allow simultaneous detection of multiple fluorophores, a 60× Planapo objective, and a cooled digital CCD camera (Quantix, Princeton Instruments), all of which are controlled by MetaMorph image processing software (version 4.6.2, Universal Imaging, Inc.). Excitation and emission filters are selected using two filter wheels (Sutter Instrument Co.) and a double pass dichroic mirror bandpass combination (436-510 DBDR and 475-550 DBEM, Omega Optical).

$${λ}_{ex}^{D}$$

is 436±5 nm,

$${λ}_{em}^{D}$$

is 480±15 nm,

$${λ}_{ex}^{A}$$

is 510+12 nm, and

$${λ}_{em }^{A} is 535 \pm 13 nm .$$

is 535±13 nm. For E_{C}(ETR),

$${λ}_{ex}^{D}$$

is provided by the Titanium:Sapphire laser tuned to 436 nm, and

$${λ}_{ex}^{A}$$

is from the argon laser (514 nm), with neutral density filters added as needed. All images (I_{F}, I_{D}, I_{A}) are collected with an exposure time of 200 ms. The images are background-subtracted and shading-corrected using the “Correct Shade” tool in MetaMorph, which performs the shading correction as: Corrected Image=(Max value of Shade Image)*(Acquired Image−Background)/(Shade Image−Background). The background image is a 20-frame average of the camera bias, taken with the identical situation as for imaging but with the excitation light blocked. The shade image is a 20-frame average of images of purified solutions of citrine and CFP, sandwiched between two coverglasses. Shading correction is crucial for obtaining uniform ratios across the CCD chip.

c. Measuring E_{C} by Donor Fluorescence Lifetime (E_{C}(DFL)) In Vitro and In Situ.

E_{C} is measured by donor fluorescence lifetime (DFL) measurements of CFP-Cit₆, CFP-Cit₁₇ and CFP-Cit₃₀, in solution and as bead-conjugates. τ_{D} is measured using CFP, and τ_{DA} is measured using the various linked CFP-Cit constructs. An inverse correlation between E_{C} and linker length is obtained, similar to CFP-YFP constructs with similarly varied linker lengths and which showed corresponding effects on N_{FRET} (Xia, Z., and Y. Liu (2001) Biophys. J. 81:2395-2402). These measurements are used as standards for the E_{C}(ETR) measurements.

Thus far, fluorescence lifetime measurements have been collected by time-correlated single photon-counting (TCSPC) PMT in both the fluorometer and the microscope. The excitation is a mode-locked Tsunami Ti:Sapphire laser, pumped with a 532 nm Millenia V laser emitting 1 picosecond 872 nm pulses, pulse-picked to 8 MHz and frequency doubled in a Model 3980 (Spectra Physics) to provide 436 nm picosecond pulses. For solution studies, the sample is placed in a custom fluorometer (Optical Building Blocks, PTI). The optical path for the microscope is the same as described above except that the excitation filter wheel is replaced with the light from the Ti:Sapphire laser transferred by an optical fiber. Emission wavelengths are selected by optical bandpass filters in the microscope emission filter wheel (as above) in front of the detector (H3809, Hamamatsu). An instrument response function (IRF) is obtained from light scattered off a solution of glycogen placed in the fluorometer, or in a custom-fabricated chamber positioned in place of the microscope cube. The fluorescence decays are collected with a TimeHarp photon-counting computer card and analyzed with the software FluoFit 3.0 (both from PicoQuant GmbH). The CFP lifetime fits a double exponential in the absence of acceptor and a triple exponential in the presence of acceptor. From these measurements of the mean fluorescence lifetime of CFP alone and of CFP-Cit (eq. A), E_{C} of CFP-Cit₁₇ was determined to be 0.40 in solutions and 0.37 inside cells. Lower E_{C} values are obtained for longer linkers. Similar measurements are performed with probes in solution, probes on beads and probes expressed in cells.

d. Determination of FRET Stoichiometry Coefficients γ and ξ.

With E_{C} defined for several different linked constructs, the coefficients γ and ξ are determined by back-calculating from equations 3 and 5. f_{A} and f_{D} of linked CFP-Cit probes equal one, therefore,

$$γ = \frac{{E}_{C}}{[ \frac{{I}_{F} - β {I}_{D}}{α {I}_{A}} - 1 ]} \qquad and \qquad ξ = \frac{γ {I}_{D} {E}_{C}}{( 1 - {E}_{C} ) ( {I}_{F} - α {I}_{A} - β {I}_{D} )}$$

In preliminary studies, γ and ξ were determined to be 0.08 and 0.010, respectively, using a single value for E_{C} (as described above). More accurate values for γ and ξ are attainable from the slopes of the plots:

$${E}_{C} vs . ⌊ \frac{{I}_{F} - β {I}_{D}}{α {I}_{A}} - 1 ⌋ ,$$

for γ; and

γI_{D}E_{C} vs. (1−E_{C})(I_{F}−αI_{A}−βI_{D}) for ξ,

using the different E_{C}s of the probes with different linker lengths.

e. Measuring E_{C} by Energy Transfer Rate (E_{C}(ETR)) In Vitro and In Situ.

Having determined E_{C}(DFL) for several linked CFP-Cit probes, as well as the coefficients α, β, γ and ξ, time-resolved fluorescence measurements for E_{C}(ETR) are collected. Î_{F}^{A}(t), the normalized, time-resolved fluorescence decay of acceptor-only in the filter combination I_{F}, is measured from cells expressing citrine only. Solutions of proteins or cells in the microscope are illuminated with pulsed 436 nm excitation from the Ti:Sapph laser, and their fluorescence decays collected by TCSPC.

Determination of E_{C} in solutions of linked probes, and from cells expressing linked probes, includes the time-resolved measurements of I_{F}(t) and I_{D}(t), using the 436 nm pulsed excitation and collecting fluorescence decays at

$${λ}_{em}^{A} and {λ}_{em}^{D} ,$$

respectively. Steady state measurement of I_{A} from those same solutions or cells are performed with

$${λ}_{ex}^{A} = 514 nm ( argon laser ) and {λ}_{em}^{A} .$$

Liquid crystal power stabilizers on both lasers will hold each laser to a fixed power, thereby maintaining proportional illumination intensities.

The fluorescence decays are subtracted from I_{F}(t) by standard methods, then the resulting I_{SE}(t) are deconvolved (with I_{F}^{A}(t)) to obtain the energy transfer excitation function, its rate k_{T}, and E_{C}. Probes with different linker lengths are contemplated to have measurably different E_{C}. A plot of E_{C}(DFL) vs. E_{C}(ETR) shows the correlation between the two methods.

f. Measuring Sensitivity of E_{C}(ETR) Measurements.

After determining E_{C} for the various linked constructs, both in vitro and in situ, the limits of detection for the E_{C}(ETR) method is measured in mixtures of linked constructs plus free CFP or citrine. This determines the lowest ratio of complex to total fluorophore in which E_{C} can be measured accurately. In cells expressing linked CFP-Cit plus CFP, E_{C} vs. R is plotted. This defines a range of R values in which E_{C} equals that measured from linked CFP-Cit alone.

C. Measuring Characteristic FRET Efficiency (E_{C}) for Unlinked, Interacting Chimeric Proteins

The method described above for measuring E_{C} by ETR is applied to measurements of E_{C} for unlinked interacting probes. A FRET-based system for detection and localization of active, GTP-bound Rac1 inside cells has been developed (Kraynov et al. (2000) Science 290:333-337). A GFP-Rac1 chimera was expressed and purified, and the p21-binding domain (PBD) of PAK1, which recognizes GTP-Rac1 but not GDP-Rac1, was purified and labeled chemically with Alexa-546, creating donor (GFP-Rac1) and acceptor (Alexa-PBD) fluorophores. In its GDP-bound, inactive form, GFP-Rac1 did not interact with Alexa-PBD; hence, excitation at 480 nm, in solution or inside cells, yielded GFP fluorescence (510 nm) without Alexa fluorescence (568 nm). However, GFP-Rac1 in its GTP-bound, active state bound to Alexa-PBD such that excitation of the GFP produced measurable Alexa fluorescence via FRET. To measure the FRET efficiency of unlinked probes, the chimeras CFP-Rac1 and citrine-PBD have been developed. These chimeras can be purified or expressed inside J774 macrophages (FIG. 12). Intracellular measurements of Rac1-PBD interactions provide quantitative exemplification of methods for measuring E_{C} when only some of the fluorophores are in complex. Later studies utilize this system to analyze donor-acceptor-complex equilibria inside cells.

1. Probes.

Available plasmids are used for bacterial expression and purification of 6His-tagged CFP-Rac1 and 6His-tagged citrine-PBD, and for expression of CFP-Rac1 and citrine-PBD inside J774 macrophages.

2. Measurement of E_{C}(ETR) of Rac1/PBD Probe Interactions.

E_{C} for the binding interaction between CFP-Rac1 and citrine-PBD is obtained by applying E_{C}(ETR) methods to solutions of the purified protein chimeras and to chimeras expressed inside J774 macrophages. Coefficients for E_{C}(ETR) are confirmed by measurements of CFP-Rac1 alone (a) and citrine-PBD alone (β, Î_{F}^{A}(t)). Then the fluorescence decays I_{F}(t) and I_{D}(t) are collected from solutions containing both proteins (mixed CFP-Rac1 and citrine-PBD) and from cells expressing both proteins. The rate of energy transfer is detectable after deconvolution (I_{FRET}(t)=I_{SE}(t) [symbol] ′I_{F}^{A}(t)). If the equilibrium distribution of FRET-positive complex to free CFP-Rac1 and citrine-PBD is too low to obtain satisfactory E_{C} for the complex, then measurements are collected in 1 mM GTPγS, which stabilizes Rac1 in a GTP-bound configuration and increases its association with PBD. E_{C} is determined at various combinations of donor and acceptor, to obtain plots of E_{C} vs. R, E_{C} vs. E_{A}, and E_{C} vs. E_{D} (with and without GTPγS). Those plots define ranges of R, E_{A} and E_{D} in which E_{C} is constant.

3. Measurement of f_{A}, f_{D} and R for Rac1/PBD Interactions, In Vitro and In Situ.

With E_{C} defined for CFP-Rac1/citrine-PBD bimolecular complexes, microscopic FRET stoichiometry is applied to cells expressing those proteins. For cells expressing various amounts of CFP-Rac1 and citrine-PBD, f_{A}, f_{D} and R are measured first for the entire cell (as in FIG. 10), then for defined subregions of the cytoplasm. Localized Rac1 activation is determined by measuring the component reaction parameters f_{A} and f_{D} during Fc receptor-mediated phagocytosis of IgG-opsonized erythrocytes, a process that requires activated Rac1 (Caron, E., and A. Hall (1998) Science 282:1717-1721; Diakonova, M. et al. (2002) Mol. Biol. Cell 13:402-411; and Araki, N. et al. (1996) J. Cell Biol. 135:1249-1260).

III. Applications of FRET Stoichiometry

Because FRET stoichiometry can be generalized to the study of multi-molecular interactions and membrane associations, it is contemplated to be especially useful for studies of the behaviors of molecules in their native pathways (Kraynov et al., 2000; Janetopoulos et al., 2001) and the binding dynamics of membrane localized proteins and microdomains (Zacharias et al., 2002). Unlike previous microscopic methods which give measurements in arbitrary units that are specific to a given instrument, the measured quantities, fraction and efficiency, are physical parameters that are transferable not only from one molecular interaction to another, but also to other fluorescence technologies, such as confocal microscopy, flow cytometry and high throughput screening. Extension of FRET stoichiometry to higher throughput modalities allows quantitative analysis of molecular interactions in populations of living cells.

Successful development of the cytometric methods, as described above and in the Examples (see, for example, Section A below and Example 11 below) allows many important intracellular signaling pathways to be analyzed quantitatively, including signaling by heterotrimeric G-proteins, receptor clustering, and other protein-protein interactions essential to signal transduction. Further improvements in pre-sort processing algorithms, some of which are already developed in the BD FACSDiVa software, are contemplated to allow cells to be sorted based on FRET stoichiometric parameters.

A. Measuring FRET Stoichiometry in Flow Cytometry

The microscopic methods described above characterize reagents that can be utilized for flow cytometry and provide protocols for determining the coefficients of FRET stoichiometry. The applicability of FRET stoichiometry to flow cytometry is demonstrated by utilizing CFP, citrine, and linked CFP-citrine, coupled to beads, in a BD FACSVantage cell sorter at the University of Michigan flow cytometry core facility.

1. Apparatus

The FACSVantage SE sorter is configured for measurement of I_{A}, I_{D} and I_{F}. A Helium:Cadmium laser is added to an available port on the sorter, providing a 440 nm line. This excitation wavelength is necessary for FRET stoichiometry, which requires a donor excitation wavelength that excites sufficient acceptor for a relatively high α (>0.25). The excitation line for acceptor (514 nm) is provided by the argon laser already in the BD FACSVantage SE. A dichroic filter (DF505LP) separates CFP and citrine emissions, and bandpass filters include 470/20 nm (for CFP emission), 546/10 nm (for citrine emission). Three PMTs detect signals corresponding to I_{A}, I_{D}, and I_{F}.

2. Measuring I_{F}, I_{A}, and I_{D}

Several different calibration beads are used to collect the component signals of FRET stoichiometry, I_{A}, I_{D}, and I_{F}. The FRET-positive beads contain the expressed construct with the highest E_{C} (contemplated to be CFP-Cit₆). FRET-negative control beads include CFP-beads, citrine-beads, and FRET-negative CFP/Cit-beads (tested by microscopic FRET stoichiometry to ensure that they exhibit no FRET). The designated channels for I_{A}, I_{D}, and I_{F} report measurable signals from FRET-positive beads and from FRET-negative, CFP/Cit-beads, with the higher I_{F} signals from the FRET-positive beads.

3. Measuring α and β, then I_{F} with Compensation

α and β are measured using CFP-beads (β) and citrine-beads (α). Standard flow cytometric methods for determination of signal cross-contamination (for compensation) obtain α=I_{F}/I_{A} and β=I_{F}/I_{D}. I_{A}, I_{D}, and I_{F} are then measured from calibration beads, applying the terms α and β as compensation coefficients. Compensated I_{F} (i.e., I_{F}−αI_{A}−βI_{D}) provide a first indication of the ability to detect FRET signals by flow cytometry. Compensated I_{F} of FRET-positive beads are contemplated to be significantly greater than that of FRET-negative, CFP/Cit control beads. Moreover, compensated FRET signals are contemplated to correlate with E_{C} (e.g., linked CFP-Cit₆-beads should exhibit higher signals than linked CFP-Cit₃₀-beads).

### EXPERIMENTAL

The following examples are provided in order to demonstrate and further illustrate certain preferred embodiments and aspects of the present invention and are not to be construed as limiting the scope thereof.

In the experimental disclosures which follow, the following abbreviations apply: N (normal); M (molar); mM (millimolar); μLM (micromolar); mol (moles); mmol (millimoles); μmol (micromoles); nmol (nanomoles); pmol (picomoles); g (grams); mg (milligrams); μg (micrograms); ng (nanograms); l or L (liters); ml (milliliters); μL (microliters); cm (centimeters); mm (millimeters); μm (micrometers); nm (nanometers); and ° C. (degrees Centigrade);

### Example 1

### A Method for Detecting FRET Between Yellow and Cyan Fluorescent Proteins

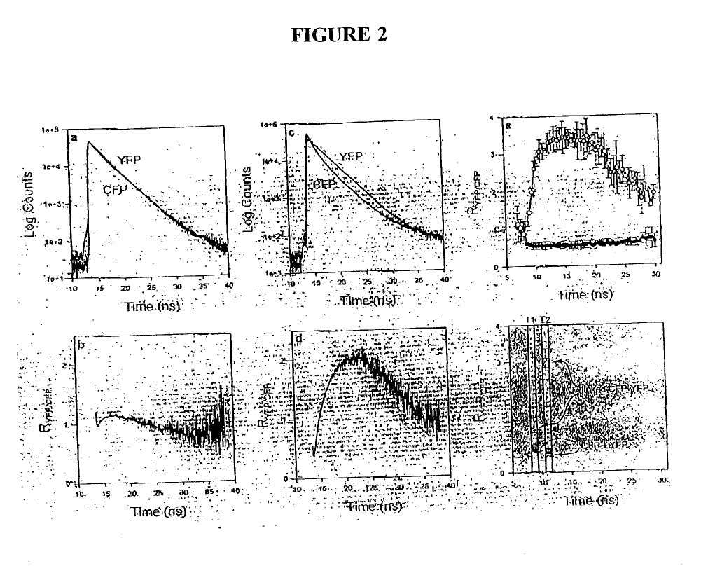

This method improves the microscopic detection of FRET by exploiting the effects of FRET on donor and acceptor polarization and fluorescence decays. This system uses a pulsed-source laser (1 picosecond per pulse) in combination with a sensitive time-resolved fluorescence detection system. The detection system provides input to a fluorescence lifetime fluorometer, which uses ultra-fast photomultiplier tubes (Hamamatsu H5783) or MCP-PMTs (Hamamatsu R3809U) and time-resolved photon-counting computer cards (Becker-Hickel SPCC730) to analyze fluorescence lifetimes with maximal sensitivity. FIG. 2A demonstrates the determination of fluorescence lifetime for Yellow Fluorescent Protein (YFP acceptor) and Cyan Fluorescent Protein (CFP donor) is approximately 3.0 nanoseconds (note that the Cyan Fluorescent Protein response is a weak double exponential). The ratiometric formula of FRET is expressed in the following formula (i.e., Example III):

R_{FRET}=YFP

CFP

Due to this identity in lifetimes when both proteins are randomly distributed in a living cell, a constant ratiometric expression of acceptor protein lifetime divided by donor protein lifetime (i.e., YFP/CFP) is obtained from FRET measurements taken in living cells following one light pulse (see FIG. 2B). FIG. 2C also presents data after a single light pulse but the proteins are placed in close proximity (e.g., linked in a single transcript; FRET-positive controls). Clearly, different fluorescent ratios are obtained when determined at different times following the light pulse. Specifically, the ratios are low immediately following the light pulse (e.g., predominately independent of the acceptor fluorescence). At increasing time points following the light pulse, however, the ratio increases due to a decreased CFP donor lifetime and to the FRET-induced excitation of the YFP-acceptor (see FIGS. 2C and 2D).

### Example 2

### A Method to Calculate an LFRET Ratio (RLFRET) Using Yellow & Cyan Fluorescent Proteins

This sensitive ratiometric method measures FRET from a ratio of YFP and CFP fluorescence intensity obtained at different times following a light pulse. The comparison of these temporally independent ratio's result in a method defined as Lifetime-Enhanced FRET, or LFRET. The method is performed using a one-photon, time-domain fluorescence lifetime imaging microscope system similar to Example 1.

A pulsed source Titanium:Sapphire laser provided trains of 1 picosecond pulses of 435 nanometer light (e.g., a stroboscopic light source operating at 80 MHz) to a sample containing linked CFP-YFP proteins. A gated image intensifier, in front of a sensitive cooled CCD camera (PicoStar, LaVision A/G) provided stroboscopic shuttering at 80 MHz. The CCD camera had independent shutters, operating in the millisecond range, that control i) how long the cells are exposed to the laser pulse train, and ii) how long the camera is exposed to the intensified images. The software program Metamorph (Universal Imaging, West Chester, Pa.) was programmed to collect the data depicted in FIG. 2F, where T1 represents fluorescence at 1-2 nanoseconds following the light pulse and T2 represents fluorescence at 3-4 nanoseconds following the light pulse. The emissions were passed through the filter system to obtain 4 spectra; YFP_{T1}, YFP_{T2}, CFP_{T1}, CFP_{T2}. FIG. 2E shows a plot of the calculated ratios following shuttering in 0.5 to 1.0 nanosecond windows at defined delay times after the pulse. The LFRET ratio (R_{LFRET}) is then calculated by the following formula (i.e. Equation IV):

R_{LFRET}=(YFP_{T2}×CFP_{T1})

(YFP_{T1}×CFP_{T2})

When the R_{LFRET} ratio is greater than one (1), FRET is present. When the RLFRET ratio is less than or equal to one (1), FRET is absent. This method provides a special advantage over previous methods in that no correction factors (i.e., the G term in Equation's 1 & 2 above) are needed to determine R_{LFRET}. This advantage should substantially improve the detection of FRET in living cells.

A second advantage of using R_{LFRET} is an improved signal-to-noise ratio when compared to current ratiometric FRET measurements. For example, Table 1 shows that the absolute signals of R_{FRET} and R_{LFRET} from the Linked CFP-YFP protein configuration are similar, but the R_{LFRET} standard deviations (SD) are substantially smaller, and thus more accurate and sensitive.

TABLE 1
Comparison of R_{FRET} and L_{FRET} Ratio's
(n = 17 cells for each condition)

| Fluorescent Protein | | |
|---|---|---|
| Configuration | RFRET | RLFRET |
| CFP + YFP | 1.00 ± 0.03 | 0.09 ± 0.02 |
| (Negative-FRET) | | |
| Linked CFP-YFP | 2.23 ± 0.44 (20% SD) | 2.05 ± 0.08 (4% SD) |
| (Positive-FRET) | | |

### Example 3

### Measurement of Anisotropy Decay by FRET in Yellow & Cyan Fluorescent Protein

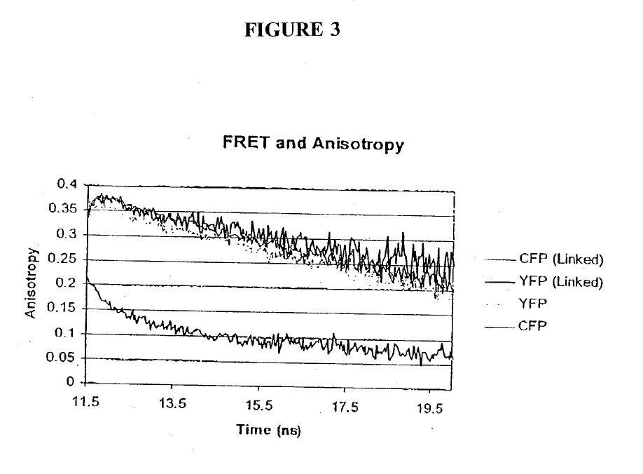

This example describes the use of purified YFP, CFP and linked YFP-CFP constructs to evaluate the effectiveness of anisotropy and anisotropy decay during FRET measurement. FRET was induced and measured as described in Example 2 with the addition of excitation and emission polarization filters. Polarization spectra were then measured for both initial fluorescence intensity and decay fluorescence intensity at each polarization (i.e., four spectra). The G factor was directed determined by rotating the polarization of the excitation light into the horizontal plane. FIG. 3 demonstrates that the emissions from both the YFP (acceptor protein) and CFP (donor protein) fluorescence is highly polarized in the negative-FRET configuration. In the linked positive-FRET configuration, however, the anisotropy decay of the YFP is largely depolarized while the decay for the CFP is only slightly depolarized.

Importantly, there is about a three-fold change in anisotropy within a nanosecond after the light pulse.

### Example 4

### Measurement of Fractional Acceptor and Donor Concentration

f_{A},f_{D} and R were determined by fluorescence measurements using CFP, citrine and CFP-citrine FRET-positive pairs. An E_{C} of 40% was determined for the linked CFP-citrine using CFP fluorescence lifetime measurements. When the total CFP/citrine ratio was decreased f_{A} decreased but there was no change in f_{D} (see FIG. 4A). This observation shows that not all of the citrine was paired, but all of the CFP was paired. Conversely, when CFP was added f_{D} changed but there was no alteration in f_{A} (see FIG. 4B). This data shows that f_{A} and f_{D} correlate with the fractions of acceptor and donor available for pairing. These obtained fractional values were used to calculate R as shown in FIGS. 4C & D. It is apparent that R is a good estimator of the ratio of acceptor to donor. Uncorrected ratio donor fluorescence plots (I_{A}/I_{D}) gave non-linear relationships with f_{A} and f_{D}. In conclusion, these data show that if E_{C} is known, the fractions of donor-acceptor pairs can be determined.

### Example 5

### Measurement of Donor-Acceptor Pairs in Transfected Cells

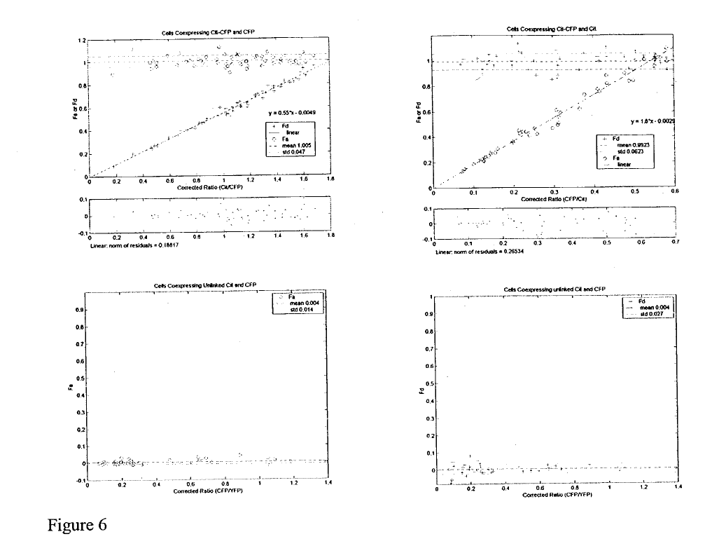

This example provides data on the measurement of FRET pairs in living cells using cyan fluorescent protein (CFP) and citrine (Cit). Specifically, J774 macrophages were transfected with three combinations of plasmid: linked CFP-Cit plus CFP, linked CFP-Cit plus citrine, and citrine plus CFP (negative-FRET control). The cells expressed various absolute amounts of CFP, citrine and linked CFP-Cit, as well as different and unknown ratios of these fluorophores inside cells. f_{A}, f_{D} and R were determined and displayed as digital images. E_{C} was independently measured by fluorescence lifetime of the donor, using time-correlated single-photon counting on cells expressing linked CFP-Cit. In cells expressing linked CFP-Cit plus citrine (see FIG. 5), the fluorescence intensities varied widely, but the data processing produced uniform calculations for f_{A}, f_{D} and R. Cellular f_{A} varied, consistent with the variable ratios of linked CFP-Cit and citrine. For example, the cell on the left of FIG. 5 exhibited a low R and a low f_{A}, indicating that it expressed much more free citrine than linked CFP-Cit. In contrast, f_{D} remained uniformly high, detecting the linked CFP-Cit, but not the citrine. FIG. 6 demonstrates the relationships described in the above models using the cumulation of the collected data. When linked CFP-Cit was co-expressed with citrine, f_{A} varied linearly with the ratio CFP/citrine, whereas f_{D} remained uniformly high; this relationship is demonstrated in FIG. 6B and indicates all the intracellular CFP is paired. A reversed relationship is seen in cells co-expressing linked CFP-Cit and CFP: f_{D} varied linearly with the Cit/CFP ratio and f_{A} remained uniformly high (see FIG. 6A). Cells expressing unlinked citrine and CFP showed variable ratios of fluorophore expression but never indicated the existence of any donor-acceptor pairs (i.e., CFP-Cit linkages). As such, the calculated values for both f_{A} and f_{D} are zero (see FIG. 6C and D). These data show that the methods contemplated in various embodiments of the present invention are quite sensitive, collect data quickly and are reliable (e.g., all f_{A} and f_{D} calculations were accurate to within 5%).

### Example 6

### Materials and Methods

This example describes the materials and methods used in developing models of, and examining the methods of, FRET stoichiometry.

1. Constructs and Protein Purification

pEYFP-C1 and pECFP-N1 (Clontech, Palo Alto, Calif.) were used directly or pEYFP-C 1 was mutated (Q69M) with by the Quickchange Method (Stratagene, La Jolla, Calif.) to produce citrine. The CFP coding region of pECFP-N1 was PCR amplified with a primer coding for an additional four glycines, restriction digested, and inserted into the pEYFP-C1 or Citrine vector between the HindIII and EcoRI restriction sites. This produced the fusions CFP-YFP and CFP-Cit, each with a 16-amino acid linker between the fluorescent proteins.

PCR Primers:

| | |
|---|---|
| 5′-ATGCAAGCTTCGGGAGGAGGAGGAGGCGGCATGGTGAGCAAGGGCGAGGAG | (SEQ ID NO:1) |
| 5′-CAAGAATTCTTACTTCTACAGCTCGTCCAT | (SEQ ID NO:2) |

The coding sequences for ECFP, EYFP, Citrine, CFP-YFP and CFP-Cit were cloned into pQE-31 (Qiagen, Chatsworth, Calif.) prokaryotic expression vector at the XmaI site to add a 6-His tag at the N-terminus. The plasmid was transferred to JM109 E. coli. The cells were grown with shaking (150 RPM) at 37° C. in LB, to an OD₆₀₀ of 0.7 and induced with IPTG for 7 hours. After induction, the culture was chilled on ice 15 min, pelleted by centrifugation (5000 g, 15 min) and resuspended in lysis buffer with lysozyme for 15 min. Lysates were passed through a French press, treated with DNase and RNase for 10 min at 4° C., cleared by centrifugation (15,000 g, 30 min), and the proteins were purified on Ni-NTA agarose according to the manufacturer's protocol (Qiagen). SDS-PAGE stained with Coomasie Blue showed the proteins to be greater than 98% pure.

2. Cell Culture and Transfection of J774 Macrophages

J774 cells obtained from ATCC were grown in Dulbecco's modified Eagle's medium supplemented with 10% fetal bovine serum (Gibco BRL, Gaithersberg, Md.) (heat-inactivated at 56° C. for 45 minutes) and 100 unit/mL of penicillin/streptomycin mixture (Sigma, St. Louis, Mo.) at 37° C. with 5% CO₂. Macrophages were plated on acid-washed coverglasses 24 hrs prior to transfection. Transfection was carried out 24 hrs prior to the experiment with 1 μg total plasmid DNA and 2 μl FuGene6 (Roche, Grenzacherstrasse, Switzerland). During microscopic observation, the cells were maintained at 37° C. on a heated stage in Ringer's buffer.

3. Image Acquisition.

The FRET microscope consisted of an inverted fluorescence microscope (Nikon TE-300, Nikon, Japan), equipped with a temperature-controlled stage, a 75W mercury arc lamp, shutters for trans- and epifluorescence illumination, filter wheels for both excitation and emission filters, dichroic mirrors that allowed simultaneous detection of multiple fluorophores, a 60× Planapo objective, and a cooled digital CCD camera (Quantix, Photometrics, Tuscon, Ariz.), all of which were controlled by Metamorph image processing software (version 4.6.2, Universal Imaging, Inc., Malvern, Pa.). Excitation and emission filters were selected using two filter wheels (Sutter Instrument Co, Novato, Calif.) and a double pass dichroic mirror bandpass combination (436-510 DBDR and 475-550 DBEM, Omega Optical, Brattleboro, Vt.). I_{A} was obtained with 510±12 nm excitation and 535±13 nm emission, I_{D} was imaged using 436±5 nm excitation and 480±15 nm emission, and the I_{F} image was collected by exciting with the 436±5 nm filter and collecting the emission with the 535±13 nm filter (Omega Optical).

4. Image Processing

All images were collected with an exposure time of 200 ms. The images were then background-subtracted and shading-corrected using the ‘Correct Shade’ tool in MetaMorph, which performs the shading correction as: Corrected Image=(Max value of Shade Image)*(Acquired Image−Background)/(Shade Image−Background). The background image was a 20-frame average of the camera bias, taken with the identical situation as for imaging but with the excitation light blocked. The shade image was collected from a 20-frame average of images of purified solutions of citrine or CFP, sandwiched between two BSA-coated coverglasses supported by coverglass fragments in 1 mg/ml electrophoresis grade BSA and 15 mM HEPES, 15 mM MES, 130 mM KCl, 1 mM MgCl₂, pH=7.2. Shading correction was necessary to obtain uniform values of E_{A}, E_{D}, and R across the CCD chip.

Following background and shading correction, the corrected I_{D} and I_{A} images were added and a manual threshold was applied to the ADD image (Table 1). The threshold was used to generate a single binary mask that was then taken as a logical AND with each of the corrected I_{A}, I_{D}, and I_{F} images. The masked images were then used to produce the FRET stoichiometry images by image arithmetic with the following equations (derived in appendix and results):

$$\begin{matrix}{f}_{A} = γ [ \frac{{I}_{F} - β {I}_{D}}{α {I}_{A}} - 1 ] ( \frac{1}{{E}_{C}} ) \\ {f}_{D} = [ 1 - \frac{{I}_{D}}{( {I}_{F} - α {I}_{A} - β {I}_{D} ) \frac{ξ}{γ} + {I}_{D}} ] ( \frac{1}{{E}_{C}} ) \\ R = ( \frac{ξ}{{γ}^{2}} ) \frac{α {I}_{A}}{( {I}_{F} - α {I}_{A} - β {I}_{D} ) \frac{ξ}{γ} + {I}_{D}}\end{matrix}$$

5. Determination of Efficiency and E_{C} by Fluorescence Lifetime

Experimental measurements of f_{A} and f_{D} required measurement of the characteristic efficiency of a linked construct (E_{C}), in which f_{A} and f_{D}=1.0. Solutions of, and cells expressing either CFP or the linked Cit-CFP construct were measured on a custom lifetime fluorometer or fluorescence lifetime microscope (with identical emission optics as the steady-state microscope) configured for time-correlated single photon counting to determine E_{C}. The excitation for both was a mode-locked Tsunami Ti:Sapphire laser pumped with 532 nm Millenia V laser emitting 1 picosecond 872 nm pulses, pulse-picked to 8 MHz and frequency doubled in a Model 3980 (Spectra Physics, Mountain View, Calif.) to provide 436 nm picosecond pulses. Lifetime measurements of purified CFP-Cit, CFP-YFP and CFP were carried out in the custom fluorometer (Optical Building Blocks, PTI, NJ). The optical path for the microscope was the same as the steady-state microscope described above, except the excitation filter wheel was replaced with the light from the Ti:Sapphire laser. Emission wavelengths were selected by a monochromator (fluorometer) or optical bandpass filters in the microscope emission filter wheel (as above) in front of the detector (H3809, Hamamatsu, Japan). An instrument response function (IRF) was obtained from light scattered from a solution of glycogen placed in the fluorometer or in a custom-fabricated chamber positioned in place of the microscope cube. The fluorescence decays were collected with a TimeHarp photon-counting computer card and analyzed with the software FluoFit 3.0 (both from PicoQuant GmbH, Germany). The CFP lifetime was well fit by a double exponential in the absence of energy transfer and by a triple exponential in the presence of energy transfer. All mean lifetimes were calculated by fitting the CFP lifetime to a triple exponential. From these measurements of the mean fluorescence lifetime of CFP and of CFP-Cit, E_{C} of CFP-Cit was determined to be 0.40 in solutions (pH=7.2) and 0.37 inside cells according to:

$$E = [ 1 - \frac{{τ}_{DA}}{{τ}_{D}} ]$$

where τ_{D} and τ_{DA} are the mean fluorescence lifetime of CFP alone or CFP-Cit respectively. For the pH titrations, the same procedure was applied to ˜1 μM purified CFP, CFP-YFP and CFP-Cit in 1 mg/ml BSA, 15 mM HEPES, 15 mM MES, 130 mM KCl, 1 mM MgCl₂, at the pHs indicated in FIG. 9.

6. Determination of the Parameters α, β, γ, ξ

The parameters α and β, defined previously by others (Erickson et al., 2001; Gordon et al., 1998; Xia and Liu, 2001; Youvan, 1997), were measured in cells transfected with DNA encoding either citrine or CFP. The images I_{A}, I_{D}, and I_{F} were collected from approximately 25 cells for each condition. α and β were calculated from the shading-corrected images of cells expressing only citrine (α) or CFP (β) as:

$$\begin{matrix}α = \frac{{I}_{F}}{{I}_{A}} , \\ β = \frac{{I}_{F}}{{I}_{D}}\end{matrix}$$

α and β for our system were 0.29 and 1.07, respectively. These values were also obtained from measurements of solutions of purified citrine and CFP, and were found to be in good agreement with the cellular measurements.

Once α and β were known, γ and ξ were determined by back-calculating from the equations for f_{A} and f_{D} in which I_{A}, I_{D} and I_{F} were collected from approximately 25 cells expressing CFP-Cit.

$$\begin{matrix}γ = \frac{{E}_{C}}{[ \frac{{I}_{F} - β {I}_{D}}{α {I}_{A}} - 1 ]} \\ ξ = \frac{γ {I}_{D} {E}_{C}}{( 1 - {E}_{C} ) ( {I}_{F} - α {I}_{A} - β {I}_{D} )}\end{matrix}$$

γ and ξ were determined to be 0.080 and 0.012 for our system.

### Example 7

### Model of FRET Stoichiometry

This example describes the development of a model of FRET stoichiometry.

To evaluate the behavior of FRET stoichiometry against physical constraints and other methods such as N_{FRET} and the ratio of I_{F}/I_{D}, a static model was generated in which total donor and acceptor were assigned a concentration. The concentration of donor-acceptor complexes was then set by changing the fraction of donor and/or acceptor in complex. The fluorescence detected from donor or acceptor, for a given set of excitation and emission bandpasses, were related to the concentration by proportionality constants P₁ and P₂ respectively. The interrelationships between filters and fluorescence excitation and emissions were set by parameters measured from our microscope system α=0.29, β=1.07, γ=0.08, ξ=0.022 (this value for ξ was estimated prior to experimental measurement, the measured value was 0.012). For example, the fluorescence intensity in I_{D} is equal to the concentration of total donors [D_{T}] times a proportionality constant P₁ less the fraction energy (E) not emitted from the fraction of donor molecules (f_{D}) in complex:

I_{D}=P₁[D_{T}](1−f_{D}E)

The acceptor fluorescence in I_{A} is unaffected by FRET and is proportional (P₂) to the concentration of total acceptors [A_{T}] present:

I_{A}=P₂[A_{T}]

I_{F} is made up of a portion of the donor spectrum, related to I_{D} by β, plus the portion of emissions from the acceptor whose fluorescence is related to I_{A} by α. The acceptor emission is made up of direct excitation plus the sensitized emission from the fraction of energy transferred (E) to the fraction of acceptors in complex (f_{A}), γ normalizes the quantity of energy absorbed by the donor and transferred to the acceptor to the fraction of energy absorbed by direct excitation of the acceptor. For simplicity, the model is presented as though the quantum yield of the acceptor is unity; however, this was not required. In the case given here, the parameter ξ simply relates the portion of wavelengths detected from the emission spectrum of the donor to the acceptor and is determined by the ratio of P₁ and P₂.

$${I}_{F} = α {P}_{2} [ \frac{{f}_{A} E}{γ} + 1 ] [ {A}_{T} ] + β {P}_{1} [ {D}_{T} ] ( 1 - {f}_{D} E )$$

### Example 8

### Results from Modeling

This example describes the results of applying the model of FRET stoichiometry described in Example 7.

To examine the behavior of these equations relative to various conditions and to other methods (Gordon, G. W. et al. (1998) Biophys. J. 74:2702-2713; Xia, Z., and Y. Liu. (2001) Biophys. J. 81:2395-2402; and Miyawaki, A. et al. (1997) Nature 388:882-887), a static mathematical model was developed, based on high affinity donor-acceptor interactions in which one species is limiting. Model conditions were first defined in which all donor and acceptor were in complex, and FRET efficiency of those complexes varied (FIG. 8A). The excitation and fluorescence emitted from each species were described by proportionality constants to the various emission band passes using parameters measured from our microscope system α=0.29, β=1.07, γ=0.08, ξ=0.022. Comparisons of FRET stoichiometry with N_{FRET} and I_{F}/I_{D} indicated that whereas E_{A} and E_{D} increased linearly with FRET efficiency, other methods were non-linear, deviating dramatically as FRET efficiency approached 1.00 (FIG. 8A). To compare the various methods for their abilities to discriminate ratios of donor, acceptor, and complex, model conditions were defined such that FRET efficiency of the complex was fixed, and the ratios of complex to unlinked donor or acceptor were varied (FIGS. 8B, C). f_{A} varied linearly with the fraction of acceptor in complex (FIG. 8B), but was independent of the fraction of donor in complex (FIG. 8C). Conversely, f_{D} reflected the fraction of donor in complex (FIG. 8C), but was unaffected by the presence of excess acceptor (FIG. 8B). FRET stoichiometry was the only method that could distinguish between excess acceptor and excess donor, and could determine correctly the fractions of acceptor, donor and complex.

### Example 9

### In Vitro Tests of FRET Stoichiometry

This example describes the results of applying the equations of FRET stoichiometry to microscopic images of mixtures of purified donor, purified acceptor, and linked donor-acceptor.

The spectral variants of GFP are a good choice for FRET imaging because the chromophore is generally protected in the core of the protein. However, the chromophore of YFP is accessible to solvent and is sensitive to pH near neutrality (Elsliger, M. A. et al. (1999). Biochemistry 38:5296-5301) and to anions such as chloride (Jayaraman, S. et al. (2000) J. Biol. Chem. 275:6047-6050), making it a questionable acceptor for physiological conditions where pH or ions can change. A recently discovered mutant of YFP (Q69M), called citrine, protects the chromophore and decreases the apparent pKₐ to that observed for other fluorescent proteins (Griesbeck, O. et al. (2001) J. Biol. Chem. 276:29188-29194), without altering its spectral properties. It was hypothesized that this mutation would maintain the chromophore in a form which should be a better acceptor for FRET. This hypothesis was examined by expressing several fluorescent proteins in E. coli, purifying them from cell lysates, and determining FRET efficiency for purified molecules of CFP, CFP covalently linked to YFP (CFP-YFP), and CFP covalently linked to citrine (CFP-Cit) by measuring donor fluorescence lifetime (DFL). These measurements, as shown in FIG. 3, confirmed the predictions about pH (FIG. 9A). Since YFP and citrine are identical except for the single point mutation at amino acid 69, the increased FRET efficiency of CFP-Cit at neutral pH indicated that the Forster distance for citrine and CFP is both pH-insensitive and nearly double that of YFP and CFP. Therefore, citrine is significantly better than YFP as a fluorescent acceptor for intracellular FRET studies.

To test the methods for calculation of f_{A}, f_{D}, and R, microscopic measurements were collected from mixtures of CFP, citrine and CFP-Cit. E_{C} of CFP-Cit was determined from CFP fluorescence lifetime measurements to be 0.40 in solution (FIG. 9A). As predicted, mixtures where the ratios of CFP-Cit to citrine were varied showed the expected variation in f_{A}, but no change in f_{D} (FIG. 9B) reflecting the condition that variable amounts of citrine (acceptor) were not part of complexes, but all of the CFP (donor) was linked to citrine. Conversely, mixtures in which ratios of CFP-Cit to CFP were varied showed that f_{D} correctly measured the fraction of donor in complex (FIG. 9C). Thus, f_{A} and f_{D} accurately reported the fractions of acceptor, donor and complex. Moreover, R was a good indicator of the ratio of acceptor to donor (FIG. 3D). Taken together, the solution studies indicated that, if E_{C} is known, FRET stoichiometry can measure the ratios of donor, acceptor and complex.

### Example 10

### Intracellular FRET Stoichiometry

This example describes the results of applying the equations of FRET stoichiometry to cells expressing various mixtures of linked and unlinked fluorophores.

To determine if fractions of donor or acceptor in complex could be measured in living cells, mixed stoichiometries of CFP, citrine, and CFP-Cit were created by transient transfection of J774 macrophages. Transfection with three combinations of plasmid: 1) linked CFP-Cit plus CFP; 2) linked CFP-Cit plus citrine; and 3) citrine plus CFP (no-FRET control); produced cells expressing different absolute amounts of CFP, citrine and linked CFP-Cit, as well as different and unknown ratios of these fluorophores inside cells. Component images were collected from cells in the microscope, then f_{A}, f_{D} and R were calculated and displayed as digital images. E_{C} was independently measured by fluorescence lifetime of the donor, using time-correlated single-photon counting on cells expressing CFP (τ_{D}) or linked CFP-Cit (τ_{DA}) The results are shown in FIG. 4.

In cells expressing CFP-Cit plus citrine (as shown in FIGS. 10A and B), the intensities of the component images varied widely, but the processed images representing f_{A}, f_{D} and R were uniform (as expected for ubiquitously expressed soluble probes in the cytoplasm). f_{A} varied from cell to cell, indicating variation in the intracellular ratios of linked CFP-Cit and citrine due to variable gene expression. For example, the cell on the left of FIG. 10B exhibited high R (Cit/CFP) and low f_{A}, indicating that it expressed much more free citrine than linked CFP-Cit. In contrast, f_{D} remained uniformly high, indicating that all CFP in that cell was as linked CFP-Cit. In cells expressing linked CFP-Cit plus CFP, f_{D} was variable and f_{A} remained high (FIG. 10C). In cells expressing CFP and citrine (no FRET) cellular ratios of CFP to citrine varied considerably with expression levels, but f_{A} and f_{D} were zero (as shown in FIG. 10D).

The cumulative measurements from three combinations of expressed fluorophores reflected the relationships described by the models and the solution studies (as shown in FIG. 11). When CFP-Cit was co-expressed with citrine, f_{A} varied linearly with the ratio CFP/citrine, whereas f_{D} remained uniformly high (indicating that all CFP in the cells was in complex; FIG. 11A). The relationship was reversed for cells co-expressing CFP-Cit and CFP: f_{D} varied linearly with the Citrine/CFP ratio and f_{A} remained uniformly high (FIG. 11B). Cells expressing unlinked citrine and CFP showed variable ratios of fluorophore expression (and variable fluorescence intensities, not shown), but never indicated the existence of complexes (f_{D} and f_{A}=0; FIG. 11C). Thus, FRET stoichiometry could determine the complete stoichiometry of donor, acceptor, and donor-acceptor complexes in living cells. The methods were also quite sensitive, component images could be collected quickly (less than 1 sec) and repeatedly, and f_{D} and f_{A} were accurate to approximately +/−5%. Cellular autofluorescence is the greatest limitation of FRET stoichiometry for cells expressing low concentrations of fluorescent chimeras, yet autofluorescence had little effect on the measurements down to CFP intensities that were only double that of the autofluorescence of neighboring untransfected cells (data not shown).

### Example 11

### Stoichiometric FRET Flow Cytometer

This example describes the assembly and testing of a stoichiometric FRET flow cytometer, capable of resolving different FRET efficiencies (CFP-Cit-beads) and capable of measuring f_{A}, f_{D} and R in cells expressing linked and unlinked CFP and citrine chimeras. The example first describes assembling optimized components for flow cytometric FRET stoichiometry and measure E, f_{A}, f_{D} and R for bimolecular interactions. The example next describes incorporating a third fluorophore detection system into the FRET flow cytometer.

A functional flow cytometer, capable of quantifying the essential parameters of bimolecular interactions, which we term f_{A}, f_{D} and R (FIG. 7C) is assembled and tested as described below. Methods for microscopic measurement of the coefficients α, β, γ, and ξ and the characteristic FRET efficiency, E_{C}, which are necessary for calculating f_{A}, f_{D} and R from the images I_{A}, I_{D}, and I_{F}, are developed and refined as described above in the General Description. Those methods are adapted to flow cytometric FRET stoichiometry, such that fluorescence intensities corresponding to I_{A}, I_{D}, and I_{F}, measured in a flow cytometer, can be analyzed to determine f_{A}, f_{D} and R for intracellular interactions between CFP- and citrine-labeled proteins.

The final technology for FRET stoichiometry is contemplated to consist of microscopic methods measuring E_{C} for any given donor-acceptor pair (e.g., E_{C}(ETR)) and flow cytometric methods for measuring f_{A}, f_{D} and R in cells passing through the cell sorter. Further advances in the technology are contemplated to allow cell sorting based on FRET parameters.

1. Assembling Optimized Components for Flow Cytometric FRET Stoichiometry and Measuring E, f_{A}, f_{D} and R for Bimolecular Interactions

A dedicated flow cytometer comprises a cell sorter; such sorters are known and available, and include but are not limited to a BD FACSDiVa cell sorter (or a Cytomation MoFlo cell sorter), into which is incorporated two lasers described above, (argon for 514 nm exc; He/Cad for 440 nm exc.), as well as a third laser for exciting marker fluorophores (He/Ne for 594 nm exc.).

a. Instrument Design and Assembly

The basic cell sorter is one of two models, the BD FACSDiVa or the Cytomation MoFlo. The following example is based upon the BD FACSDiVa (a modified BD FACSVantage SE). The layout is generally as shown schematically in FIG. 13 (adapted from BD Biosciences literature and FIG. 7 of Chan et al. (2001) Cytometry 44). The argon laser (laser 1) provides 514 nm exc., and the He/Cad laser (laser 2) provides 440 nm exc. (the He/Ne laser are added as described below in section 2). PMTs for forward scatter and side scatter are at positions P1 and P2, with BP513/10 bandpass filters detecting scatter from laser 1. A 3-laser beam-splitter (OBS2) diverts signal to a longpass dichroic mirror (DM505LP), which directs the I_{D} signal to FL5/P6 (470/20BP) and I_{F} signal to FL4/P5 (546/10BP). A shortpass dichroic mirror (DM610SP) directs longer wavelengths to FL2/P4 (not shown in diagram), for detection of red fluorescence excited by laser 3. Another shortpass dichroic mirror (DM560SP), together with a bandpass filter (546/10BP) directs I_{A} signal to FL1/P3 (laser delay corrections discriminate the I_{F} from the I_{A} signals). The digital features of the FACSDiVa provide increased sensitivity over analogue detectors. Voltage from fluorescent signals is digitized at very high rates by A/D converters. This earlier digital processing allows more sensitive detection of signals, eliminates signal dead time, and allows more complex data processing algorithms to direct cell sorting. The software allows data processing that will accommodate the algorithms of FRET stoichiometry (compensation, spillover correction, and ratiometric processing).

b. Measuring I_{F}, I_{A}, I_{D}, α, β, γ, and ξ

Initial measurements and characterizations are performed using the calibration beads developed in section IIB1 of the General Description, which are contemplated to have measurably distinct characteristic FRET efficiencies (E_{C}). I_{A}, I_{F} and I_{D} are collected in channels FL1, FL4 and FL5, respectively. α and β are measured using citrine-beads and CFP-beads, respectively, as described in section III of the General Description. γ and ξ are measured as in section II.B.4. of the General Description, by obtaining the slopes of the plots,

$${E}_{C} vs . ⌊ \frac{{I}_{F} - β {I}_{D}}{α {I}_{A}} - 1 ⌋$$

(for γ) and γI_{D}E_{C} (vs. (1−E_{C})(I_{F}−αI_{A}−βI_{D}) (for ξ), using calibration beads containing CFP-Cit of different E_{C}s (different linker lengths). The data analysis for these calculations are all done after a run, using standard data analysis software (e.g., CellQuest Pro or the newer PC-based software for the BD FACSDiVa).

C. Discriminating Cells Expressing Probes with Different FRET Efficiencies (E)

Cells expressing CFP-Cit₆, the linked construct contemplated to have the highest E_{C}, are run through the flow cytometer, gating for probe-expressing cells using both I_{D} and I_{A}. Post-run processing of the signals I_{A}, I_{F} and I_{D}, using eq. 4, determines E for those cells expressing fluorophore (for linked probes, f_{A} equals one). Similar methods are applied to cells expressing both CFP and citrine (no-FRET control), which after processing are contemplated to have E values near zero. Statistical methods are applied to the processed data to determine the sensitivity of the methods and equipment for distinguishing FRET from non-FRET signals.

Once satisfactory discrimination of FRET efficiency is indicated by flow cytometry of cells expressing linked and unlinked probes, the system is further tested by measuring signals from mixed populations of cells. One set of cells expresses CFP-Cit₆, and a separate set of cells expresses CFP plus citrine. The two populations are mixed before analysis by flow cytometry. Cells are gated based on ID and IA intensities, to identify cells with comparable levels of fluorophores, then signals are processed to determine E. Once discrimination of flow cytometric stoichiometry is adequate, the FRET and non-FRET populations of cells are distinguishable as two discrete populations of cells.

d. Measuring f_{A}, f_{D} and R

Cells expressing various linked constructs, plus unlinked CFP or citrine, are analyzed by flow cytometry, then equations 5 (f_{A}), 7 (f_{D}), and 9 (R) are applied to the data using methods analogous to the microscopic methods described for Intracellular FRET stoichiometry of Example 10. Processing is contemplated to yield distributions of f_{A}, f_{D} and R, like those shown in FIG. 11. FRET Stoichiometric parameters are also measured from cells expressing CFP-Rac1 and citrine-PBD. The distributions of f_{A} and f_{D}, relative to R and to total intensity are measured, to define effects of probe concentration on intracellular equilbria between free and complexed probes.

2. Incorporating a Third Fluorophore Detection System into the FRET Flow Cytometer

The flow cytometer developed as described in section 1 of this Example is contemplated to be capable of measuring essential parameters of bimolecular FRET interactions. The utility of this system for analytical biochemistry inside cells is enhanced considerably by adding technology for manipulating those chemistries. For example, although Rac1 activation inside cells can be measured using the CFP-Rac1/citrine-PBD FRET probes described above, the regulation of that activation could be analyzed more completely if molecules that modulate Rac1 activation could be introduced into the cells along with the FRET probes. Cells expressing altered modulatory molecules, such as GEFs (FIG. 12), could be identified if the expression of such molecules were indicated by a third fluorophore. The spectrum of that fluorophore must be sufficiently different from those of CFP and citrine that it does not interfere with FRET stoichiometry. The fluorescent protein hcRed (Clontech) satisfies those criteria.

a. Instrumentation

This technology is added to the FRET flow cytometer described above in Section 1 of this Example by incorporating a Helium/Neon laser (exc. 594 nm) for detection of cells expressing hcRed. A shortpass dichroic mirror (DM610SP) directs longer wavelength fluorescence to FL2/P4 (through bandpass filter 610/20BP; FIG. 13), for detection of hcRed excited by laser 3.

b. Measurements

Cells are transfected with plasmids encoding CFP-Rac1 and citrine-PBD, as well as the bicistronic vector encoding hcRed and the Rac1-activating protein Vav1 (a guanine-nucleotide exchange factor, or GEF (Chimini, G., and P. Chavrier (2000) Nature Cell Biol. 2:E191-E196, FIG. 12). Flow cytometry is optimized to gate hcRed-positive cells with suprathreshold signals in ID and IA. This restricts measurements to cells expressing Vav1 plus levels of CFP-Rac1 and citrine-PBD sufficient for FRET stoichiometry. Controls include cells expressing hcRed without Vav1 (empty vector). Expression of Vav1 is contemplated to increase activation of Rac1 relative to control cells, evident as increased f_{A} and f_{D} for the CFP-Rac1/citrine-PBD FRET signals. To make certain that hcRed fluorescence does not interfere with FRET stoichiometric measurements, additional control experiments are performed, measuring E (eq. 4) in cells expressing linked CFP-Cit₆ with and without hcRed. The first measurements microscopic FRET stoichiometry, as in FIG. 11. hcRed fluorescence (Texas Red filter set) and FRET efficiency (E) are measured in populations of cells, plotting E vs. hcRed fluorescence intensity. It is contemplated that hcRed fluorescence does not contribute to the component signals I_{D}, I_{A} and I_{F}, and that measured E remains constant at all intensities of hcRed. Analogous spectral interference control experiments are performed in the flow cytometer.

c. The Complete Flow Cytometer for FRET Stoichiometry

The fully assembled flow cytometer consists of three lasers (He/Cad, argon, and He/Ne) incorporated into a Cytomation MoFlo or BD Biosciences FACSDiVa cell sorter. Detectors report forward-angle scatter, side scatter, and fluorescence at 470 nm (CFP, for I_{D}), 540 nm (citrine, for I_{A} and I_{F}) and 613 nm (hcRed). Calibration experiments determine the coefficients, α, β, γ, and ξ for the device. Processing algorithms will use fluorescence compensation and spillover software, along with ratiometric methods, to calculate the essential parameters of FRET stoichiometry: E_{A}, E_{D} and R. Independent methods for determination of E_{C} for particular FRET pairs allow calculation of f_{A} and f_{D} from FRET flow cytometric data.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A device for measuring FRET stoichiometry, comprising:
a) a fluorescence detection component; and
b) a processor configured to calculate FRET stoichiometry from fluorescence information obtained by said fluorescence detection component.

2. The device of claim 1, wherein said detection component comprises a microscope configured to collect fluorescent energy.

3. The device of claim 1, wherein said detection component is calibrated for α, β, γ, and/or ξ to permit the determination of a molar ratio of donor and acceptor fluorophores in a cell.

4. The device of claim 1, wherein said processor is configured to obtain a value for γ.

5. The device of claim 4, wherein said value for γ is obtained by back-calculating from measured values of E_{C}, α, β, I_{A}, I_{D} and/or I_{F} collected from said detection component, wherein said detection component collects data from linked and unlinked biological molecules in a cell.

6. The device of claim 1, wherein said processor is configured to obtain a value for ξ from information obtained from said detection component.

7. The device of claim 1, wherein said processor obtains a ratio of total acceptor to total donor fluorescence signal to provide a quantitative measure of relative concentrations of biological molecules in a cell.

8. The device of claim 1, wherein said processor is configured to calculate FRET stoichiometry from interacting fluorescent chimeras in a cell.

9. The device of claim 1, wherein said processor generates data that determines the location and stoichiometry of molecular interactions in a cell.

10. The device of claim 1, wherein said device comprises a confocal microscope.

11. The device of claim 1, wherein said device comprises a flow cytometer.

12. The device of claim 1, wherein said fluorescence detection component is configured to collect fluorescent information from a plurality of biological samples and wherein said processor is configured to calculate FRET stoichiometry from said plurality of biological samples.

13. The device of claim 12, wherein said plurality of biological samples comprises 96 or more biological samples.

14. A method for measuring FRET stoichiometry, comprising:
a) providing:
i) a cell containing one or more target molecules;
ii) a device comprising a fluorescence detection component;
and a processor configured to calculate FRET stoichiometry from fluorescence information obtained by said fluorescence detection component;
b) collecting fluorescent information from said cell using said fluorescence detection component; and
c) calculating FRET stoichiometry from said fluorescent information using said processor.

15. The method of claim 14, wherein said detection component comprises a microscope configured to collect fluorescent energy.

16. The method of claim 14, wherein said detection component is calibrated for α, β, γ, and/or ξ to permit the determination of a molar ratio of donor and acceptor fluorophores on said one or more target molecules.

17. The method of claim 14, wherein said processor obtains a value for γ.

18. The method of claim 17, wherein said value for γ is obtained by back-calculating from measured values of E_{C}, α, β, I_{A}, I_{D} and/or I_{F} collected from said detection component, wherein said detection component collects data from linked and unlinked target molecules in said cell.

19. The method of claim 14, wherein said processor obtains a value for ξ from information obtained from said detection component.

20. The method of claim 14, wherein said processor obtains a ratio of total acceptor to total donor fluorescence signal to provide a quantitative measure of relative concentrations of said target molecules in said cell.

21. The method of claim 14, wherein said target molecules comprise fluorescent chimerical molecules.

22. The method of claim 14, wherein said processor generates data that determines the location and stoichiometry of said target molecules in said cell.

23. The method of claim 14, wherein said device comprises a confocal microscope.

24. The method of claim 14, wherein said device comprises a flow cytometer.

25. A method for determining, for an interaction between fluorescent donor molecules D and fluorescent acceptor molecules A, a fraction of acceptor molecules in complex with donor molecules (f_{A}), a fraction of donor molecules in complex with acceptor molecules (f_{D}), and a ratio of total acceptor molecules to total donor molecules (R) comprising:
a) providing
i) a solution comprising fluorescent donor molecules D and fluorescent acceptor molecules A, and
ii) the device according to claim 1,
b) calibrating the device to determine α, β, γ, and ξ;
c) determining E_{C} for the interaction;
d) obtaining fluorescence images or intensities I_{A}, I_{D}, and I_{F}; and
e) utilizing these values in eq. 2 to calculate f_{A}, in eq. 4 to calculate f_{D}, and in eq. 6 to calculate R.

26. A method for determining, for an interaction between fluorescent donor molecules D and fluorescent acceptor molecules A, a measure proportional to the fraction of acceptor molecules in complex with donor molecules (E_{A}), a measure proportional to the fraction of donor molecules in complex with acceptor molecules (E_{D}), and a ratio of total acceptor molecules to total donor molecules (R), comprising:
a) providing
i) a solution comprising fluorescent donor molecules D and fluorescent acceptor molecules A, and
ii) the device according to claim 1;
b) calibrating the device to determine α, β, γ, and ξ;
c) obtaining fluorescence images or intensities I_{A}, I_{D}, and I_{F}; and
d) utilizing these values in eq. 3 to calculate E_{A}, in eq. 5 to calculate E_{D}, and in eq. 6 to calculate R.

27. A method of determining, for an interaction between fluorescent donor molecules D and fluorescent acceptor molecules A, γ, and ξ, comprising:
a) providing
i) a solution comprising linked fluorescent donor-acceptor probe molecules, and ii) the device according to claim 1;
b) determining E_{C} for a linked donor-acceptor probe, such that f_{A} and f_{D} equal one
c) calculating γ by back-calculating from eq. 3 as
$$γ = \frac{{E}_{C}}{[ \frac{{I}_{F} - β {I}_{D}}{α {I}_{A}} - 1 ]} ;$$
and c) calculating ξ by back-calculating from eq. 5 as
$$ξ = \frac{γ {I}_{D} {E}_{C}}{( 1 - {E}_{C} ) ( {I}_{F} - α {I}_{A} - β {I}_{D} )} .$$

28. A method for determining, for an interaction between fluorescent donor molecules D and fluorescent acceptor molecules A, E_{C} by energy transfer rate (E_{C}(ETR)), comprising:
a) providing
i) a solution comprising fluorescent donor molecules D and fluorescent acceptor molecules A, and
ii) the device according to claim 1;
b) calibrating the device to determine α and β by fluorescence lifetime spectroscopy;
c) determining I_{SE}(t) from component terms I_{F}(t), I_{D}(t), and inferred I_{A}(t);
d) determining I_{FRET}(t) from I_{SE}(t) and deconvolution of
$${I}_{F}^{A} ( t ) ;$$
e) obtaining a mean rate constant K_{T} for I_{FRET}(t); and
f) obtaining E_{C} as a direct function of K_{T}.
